(19) United States
(12) Patent Application Publication
(10) Pub. No.: US 2009/0111759 A1
(43) Pub. Date: Apr. 30, 2009

(54) Synergistic Combination of Glutamate-and Gaba-Gated Chloride Agonist Pesticide and at Least One Vitamin E, Niacin, or Derivatives Thereof

(76) Inventors: Morten Pedersen, Lemvig (DK); Henriette Sie Woldum, Vejle (DK)

Correspondence Address: JACOBSON HOLMAN PLLC, 400 SEVENTH STREET N.W., SUITE 600, WASHINGTON, DC, 20004, US

(21) Appl. No.: 12/224,716

(22) PCT Filed: Mar. 8, 2007
(86) PCT No.: PCT/DK2007/050030

§ 371 Date: Sep. 4, 2008

(30) Foreign Application Priority Data
Mar. 9, 2006 (EP) 06388016.5

(51) Int. Cl. A01N 43/24; A01N 43/16; A01N 43/40; A01P 7/00

(52) U.S. Cl. 514/28; 514/458; 514/356; 514/53; 514/450

(57) ABSTRACT

Presented are pesticidal compositions comprising at least one pesticide selected among Glutamate- or GABA-gated chloride channel agonist pesticides and at least one synergist which is selected among Vitamin E, Niacin and derivatives thereof. The combinations of these compounds show a synergistic effect allowing a composition to be prepared comprising a lesser amount of pesticide, while still controlling the harmful pests.

### FIELD OF THE INVENTION

The present invention relates to pesticidal compositions in general. In particular, the present invention relates to a method of obtaining a pesticidal composition containing a pesticide and a synergist, a method of reducing the amount of pesticide in a pesticidal composition while maintaining the pesticidal effect, a method for controlling harmful pests on plants, a method for controlling harmful pests in or on animals including humans, a method for obtaining reduced application rates of a pesticide while maintaining the pesticidal effect, and a method for obtaining reduced dose rates of a pesticide while maintaining the pesticidal effect. The pesticide used in the pesticidal composition is selected among Glutamate- or GABA-gated chloride channel agonist pesticides.

### BACKGROUND

Pesticidal active compounds whose targets are insects and other arthropods and nematodes usually have a neurological effect on such pests. Their pesticidal target sites are defined as the specific biochemical or physiological sites within an organism that pesticide compounds interact with to create a toxic effect. Among neurological target sites are acetylcholinesterase enzyme, voltage-gated sodium channels, Glutamate- and GABA-gated chloride channels and nicotinic acetylcholine receptors. The actions of pesticides at these sites are diverse and range from enzyme inhibition, to receptor agonism (stimulation), receptor antagonism (blockage), and ion channel modulation. Glutamate and gamma-aminobutyric acid (GABA) are inhibitory neurotransmitters that elicit the influx of chloride ions into central neurons through chloride channels.

In U.S. Pat. No. 4,560,677 synergistic compositions are disclosed comprising avermectins or milbemycins and a synergist selected among agricultural spray oils.

The use of Vitamin E compounds and Niacin compounds as dietary supplements and as antioxidants is well known. However other functions have been described as well. Vitamin E used as an agent to increase the resistance in plants against pests and pathogens is known from U.S. Pat. No. 5,004,493. In German patent application no. DE 4437945 A1 it is suggested to use Vitamin E to protect plants against injury from other pesticides (i.e. as a safener compound). PCT publication no. WO 2004/95926-A2 describes the use of antioxidants in treatment of plants and plant propagation material to improve plant health and yield. The use of Vitamin E (acetate) as a stabilizer in veterinary formulations comprising avermectins is known from U.S. Pat. No. 6,340,672, PCT publication no. WO 2005/37294-A1 and Brazilian patent publication no. BR PI-0102125. The latter disclose the use of a nutritive composition comprising Ivermectin and vitamin E for the treatment of parasites in farm animals, which composition further comprises e.g. mineral salts, amino acids and vitamins. In PCT publication no. WO 2000/50009-A1 compositions are disclosed wherein a pharmacologically active compound is encapsulated in liposomes; the active compound is selected among e.g. avermectins, milbemycins and piperazine and the compositions may further comprise nutrients such as vitamins e.g. Vitamin E.

An insecticidal composition must satisfy a range of requirements to be viable on the market. One such requirement of the pesticidal composition is the ability to be selective in biologic action and have low toxicity and a high margin of safety to humans, crops, economic animals, aquatic organisms and birds. Another requirement is the desire that the composition should be environmental-friendly in that there should be demonstrably low impacts on the environment. Further, there should be none or little insect resistance to such compounds or combinations. Also, there is a need for improved compositions which are not only more effective against particular pests, but which are also versatile and can be used to combat a wide-spectrum of pests.

There is an increasing demand and need for pesticidal compositions, which can be used against pests afflicting beneficial crops as well as animals, including humans or their environments, and which are effective at low application rates of the pesticide. The present invention is directed towards such pesticidal compositions in which the pesticide can be applied in a low application rate or a low dose rate. Thus, the environment is favoured as the total amount of pesticide applied to a field for a certain pesticidal effect to be obtained is lowered. As the pesticide is far the most expensive component in a pesticidal composition, also the cost for producing the pesticidal composition is low.

### DESCRIPTION OF THE INVENTION

It has now surprisingly been found that by combining Glutamate- or GABA-gated chloride channel agonist pesticides (A) with at least one synergist (B) which is selected among Vitamin E compounds and Niacin compounds an enhanced pesticidal activity of the chloride channel agonist pesticides is observed when used for the control of harmful pests, i.e. a synergistic interaction between the chloride channel agonist pesticides and the compound(s) B is observed.

According to a first aspect of the invention a method of obtaining a pesticidal composition containing a pesticide and a synergist is disclosed, said composition having an actual pesticidal effect higher than the sum of pesticidal effects of each of the pesticide and the synergist when taken alone, comprising the step of replacing a part of the amount of pesticide, which is selected among glutamate- or GABA-gated chloride channel agonist pesticides, by a synergistic amount of a synergist selected among Vitamin E compounds and Niacin compounds. The pesticidal composition obtained according to this aspect is more environmental-friendly than a traditional composition containing the same pesticide since less pesticide is used to obtain a pesticidal effect.

According to a second aspect, a method of reducing the amount of pesticide in a pesticidal composition while maintaining a similar pesticidal effect is disclosed. The method comprises the step of replacing a part of the amount of pesticide, which is selected among glutamate- or GABA-gated chloride channel agonist pesticides, by a synergistic amount of a synergist selected among Vitamin E compounds and Niacin compounds. As the pesticide generally is the most expensive part of the pesticidal composition, the method of the present aspect benefits from that by providing a less expensive pesticidal composition.

In a third aspect, the present invention provides a method for controlling harmful pests on plants. The method involves applying to a plant to be treated a composition containing a pesticide and a synergist, said composition having an actual pesticidal effect higher than the sum of pesticidal effects of each of the pesticide and the synergist when administered alone, wherein a part of the amount of pesticide, which is selected among glutamate- or GABA-gated chloride channel agonist pesticides, is replaced by a synergistic amount of a synergist selected among Vitamin E compounds and Niacin compounds. In this aspect of the invention a less expensive pesticidal composition may applied to a plant to obtain a satisfactory pesticidal effect.

In a fourth aspect of the invention a method for controlling harmful pests in or on animals including humans is provided. The method comprises administrating to an animal or a human in need thereof a pharmaceutical or veterinary effective amount of a composition containing a pesticide and a synergist, said composition having an actual pesticidal effect higher than the sum of pesticidal effects of each of the pesticide and the synergist when administered alone, wherein a part of the amount of pesticide, which is selected among glutamate- or GABA-gated chloride channel agonist pesticides, is replaced by a synergistic amount of a synergist selected among Vitamin E compounds and Niacin compounds. As pesticides generally are alien to the human or animal body they should be used in a small amount to avoid any side effects. According to this aspect a method is provided for effective treatment of animals or humans suffering from a disease emanating from pests using a minimum of pesticide.

According to a fifth aspect of the present invention a method for obtaining a reduced application rate of a pesticide is deviced. The method comprises the steps of providing a pesticidal composition containing a pesticide, which is selected among glutamate- or GABA-gated chloride channel agonist pesticides, and an synergistic mount of a synergist selected among Vitamin E compounds and Niacin compounds, and applying the pesticidal composition to a plant in an amount sufficient for controlling harmful pest. The application rate is generally measured as the amount of active ingredient, i.e. pesticide, applied to a certain area, such as hectare or acre. According to this aspect of the invention the environment benefits from the application of a minor amount of pesticide while the harmful pests are still controlled. Further, by lowering the application rate, the pre-harvest interval (PHI) recommended for use in benificial crops, i.e. the time between the last pesticide application and harvest of the treated crops, is lowered, and thus providing improved protection of the crops against harmful pests as close to the time of harvest as possible without increasing undesired residual effects cause by the applied pesticide and/or possible breakdown products thereof.

According to a sixth aspect of the invention, a method for obtaining reduced dose rate of a pesticide is provided. More specifically, the method involves the steps of providing a pesticidal composition containing a pesticide, which is selected among glutamate- or GABA-gated chloride channel agonist pesticides, and an synergistic mount of a synergist selected among Vitamin E compounds and Niacin compounds, administering the pesticidal composition to an animal or a human in need thereof in a pharmaceutical or veterinary effective amount sufficient for controlling harmful pest. The dose rate is generally measured as the amount of pesticide administrated per weight of the animal or human in need of a treatment. This aspect provides a method in which a less amount of pesticide can be used for controlling harmful pest. Further, by lowering the dose rate, undesired residual effects cause by the applied pestice and/or possible breakdown products thereof is reduced.

Generally, the compositions are active against all or individual stages of development of the pests and against normally sensitive species and resistant species, i.e. species that have developed resistance against the pesticides (A). The compositions may also be useful for controlling pests that have proven to be uneffected by the pesticides (A) either completely or requiring unacceptable high doses to provide adequate control.

In an aspect of the invention it relates to a pesticidal composition comprising at least one compound A which is selected among Glutamate- or GABA-gated chloride channel agonist pesticides and at least one compound B which is selected among Vitamin E compounds and Niacin compounds, wherein the compounds A and B are present in a synergistically effective amount.

The invention also relates to a kit comprising (i) a first composition comprising at least one pesticide selected among glutamate- or GABA-gated chloride channel agonist pesticides and (ii) a second composition comprising a synergistic amount of a synergist selected among Vitamin E compounds and Niacin compounds. In this connection the term “a kit” is intended to mean a collection of at least two items intended for coordinated use, i.e. for use as a mixture or for a specified consecutive use. The components of the kit may be provided in one package, or it may be provided in separate packages. Further the kit usually comprises written instruction for the intended use.

The invention further relates to various uses. In an aspect the invention relates to the use of a synergist selected among vitamin E compounds and Niacin compounds for enhancing the effect of a pesticidal composition comprising a pesticide, which is selected among glutamate- or GABA-gated chloride channel agonist pesticides. In another aspect the invention relates to the use of a synergist selected among Vitamin E compounds and Niacin compounds for preparation of a pesticidal composition having a reduced amount of pesticide while maintaining a similar pesticidal effect, wherein the pesticide is selected among glutamate- or GABA-gated chloride channel agonist pesticides. In yet another aspect the invention relates to the use of a synergist selected among Vitamin E compounds and Niacin compounds for reducing the application or dose rates of a pesticidal composition in the control of pests while maintaining a similar pesticidal effect, wherein the pesticide is selected among glutamate- or GABA-gated chloride channel agonist pesticides. In a further aspect the invention relates to the use of a pesticide selected among glutamate- or GABA-gated chloride channel agonist pesticides, and a synergist selected among Vitamin E compounds and Niacin compounds, for the manufacture of a medicament for the control of pests in or on humans or animals or their environs, said medicament comprising a reduced amount of pesticide while maintaining a similar pesticidal effect by replacing a part of the amount of pesticide with a synergistic amount of the synergist.

### DETAILED DISCLOSURE OF THE INVENTION

Glutamate- or GABA-gated chloride channel agonist pesticide compounds are a well known and versatile group of compounds that are used as agrochemicals and as drugs within both human and veterinary medicine. The compounds are known to have both insecticidal, acaricidal and anthelminthic effect even when applied at very low rates compared to other agrochemicals and drugs. They are equally suitable for controlling both plant pests and ecto- and endo-parasites in animals and humans. Their mode of action is based on the interference with the passage of chloride ions through the Glutamate or GABA regulated chloride ion channels, which results in uncontrolled physiological activity and subsequent death of the pest. The effect is inhibitory, i.e., the compound interferes agonistically with the function of the Glutamate- or GABA-gated chloride channels and elicits increased chloride current into cells. The increased chloride current results in intracellular hyperpolarization and (neuro)inhibition via the cancellation of positively charged excitatory impulses carried by sodium currents, and eventually leads to the death of the pest. By the term “agonist” is meant a chemical that produces a response, such as excitation or inhibition of action potentials when it binds to a specific receptor, opposed to an “antagonist” which is a chemical that, when it binds to a receptor, blocks the receptor and prevents it from responding.

Among the Glutamate and GABA-gated chloride channel agonist pesticides are macrocyclic lactone compounds, which have a complex ring structure, and include the well known groups of avermectins, milbemycines and the spinosyns. The compound piperazine and salts thereof is also a known Glutamate and GABA-gated chloride channel agonist pesticide. These pesticides are known not to possess a rapid knock-down-effect, e.g. significantly lower than that observed with insecticidal compounds from the group of pyrethroids.

The avermectins are a group of macrocyclic lactone compounds produced by fermentation of Streptomyces avermitilis and mutations thereof. The individual avermectins, either naturally derived or prepared by synthetic means (e.g. Ivermectin), are usually mixtures of up to 8 major components designated as A₁ₐ, A_{1b} A₂ₐ, A_{2b}, B₁ₐ, B_{1b} B₂ₐ, B_{2b} in various ratios. For instance Abamectin is a mixture of the two closely structurally related components designated B₁ₐ and B_{1b} usually in a 80:20 ratio, whereas the active compound known as Aversectin C further comprises additional components in addition to those in Abamectin. Avermectin compounds are, for example, known from U.S. Pat. No. 3,950,360; U.S. Pat. No. 4,310,519; U.S. Pat. No. 4,378,353; U.S. Pat. No. 5,288,710; U.S. Pat. No. 4,427,663; U.S. Pat. No. 4,199,569; U.S. Pat. No. 5,015,630; U.S. Pat. No. 5,089,480, U.S. Pat. No. 5,981,500 and PCT publication no. WO 02/068442-A1.

The structure of the avermectins can be illustrated by the general formula (1), which only serves an illustrative purpose:

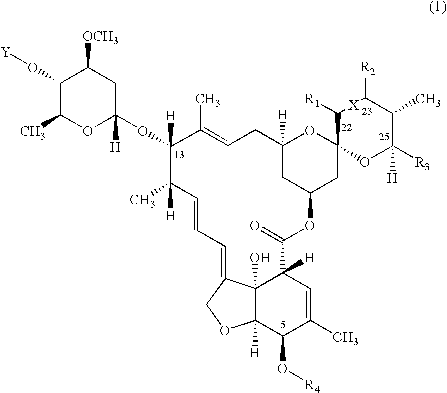

When X represents a double bond, the substituents R₁ and R₂ on the C-22 and C-23 positions are not present. Illustrative substituents in the above formula (1) are those where Y represents H or an optionally substituted sugar or aminosugar unit, R₁ represents H, R₂ represents H or hydroxy, R₃ represents alkyl or cycloalkyl and R₄ represents H or alkyl. Examples of avermectins falling within the general structure (1) are:

| Name | Y | —C22R₁—X—C23R₂ | R₃ | R₄ |
|---|---|---|---|---|
| Avermectin A₁ₐ | 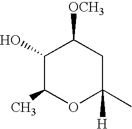 | —CH═CH— | sec-Butyl | CH₃ |
| Avermectin A_{1b} | 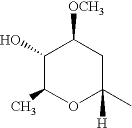 | —CH═CH— | iso-Propyl | CH₃ |
| Avermectin A₂ₐ | 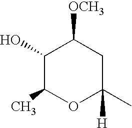 | —CH₂—CHOH— | sec-Butyl | CH₃ |
| Avermectin A_{2b} | 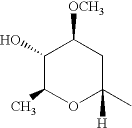 | —CH₂—CHOH— | iso-Propyl | CH₃ |
| Avermectin B₁ₐ | 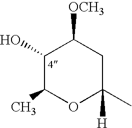 | —CH═CH— | sec-Butyl | H |
| Avermectin B_{1b} | 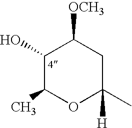 | —CH═CH— | iso-Propyl | H |
| Avermectin B₂ₐ | 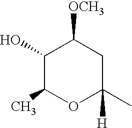 | —CH₂—CHOH— | sec-Butyl | H |
| Avermectin B_{2b} | 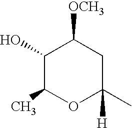 | —CH₂—CHOH— | iso-Propyl | H |
| Ivermectin B₁ₐ | 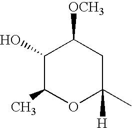 | —CH₂—CH₂— | sec-Butyl | H |
| Ivermectin B₂ₐ | 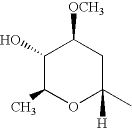 | —CH₂—CH₂— | iso-Propyl | H |
| Doramectin | 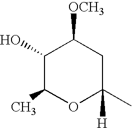 | —CH═CH— | Cyclohexyl | H |
| Emamectin B₁ₐ | 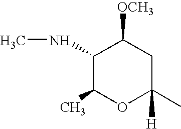 | —CH═CH— | sec-Butyl | H |
| Emamectin B_{1b} | 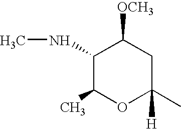 | —CH═CH— | iso-Propyl | H |
| Eprinomectin B₁ₐ | 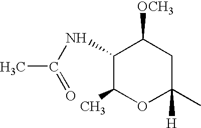 | —CH═CH— | sec-Butyl | H |
| Eprinomectin B_{1b} | 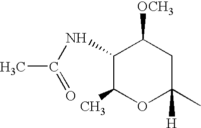 | —CH═CH— | iso-Propyl | H |

Another avermectin is Selamectin known from U.S. Pat. No. 5,981,500. Yet another group of avermectins are those disclosed in U.S. Pat. No. 6,933,260, which are derivatives of the avermectins B₁ having an aminosulfonyloxy substituent in the 4″-position as indicated above. Avermectin compounds wherein the substituent at the 5-position in the above formula (1) is a substituted oximino group or the keto group are also known. When appropriate, the avermectins also include various salt forms thereof, e.g. Emamectin as its benzoate salt.

The milbemycins differ structurally from the avermectins, mainly in the absence of the sugar residue on the C-13 carbon. Milbemycins are produced by fermentation of Streptomyces species, which further can be altered by synthetic means (e.g. Lepimectin). Milbemycins include Milbemectin and Milbemycin oxime, the latter produced by fermentation of the actinomycete Streptomyces hygroscopicos aureolacrimosus, and Moxidectin, produced by chemical modification of the milbemycin Nemadectin, a product of fermentation of Streptomyces cyanogriseus noncyanogenus. The individual milbemycins, either naturally derived or prepared by synthetic means, are also usually mixtures of several major components. For instance Milbemectin is a mixture of two major components designated as A₃ and A₄. Milbemycins are known, for example, from U.S. Pat. Nos. 3,950,360; 4,547,520, U.S. Pat. No. 4,900,753; U.S. Pat. No. 5,346,918; U.S. Pat. No. 5,428,034; U.S. Pat. No. 4,587,247; U.S. Pat. No. 5,405,867; U.S. Pat. No. 5,276,033; U.S. Pat. No. 4,945,105; U.S. Pat. No. 4,963,582; U.S. Pat. No. 4,869,901 and U.S. Pat. No. 5,614,470. When appropriate, the milbemycins also include various salt forms thereof.

The spinosyns are also fermentation products produced by Saccharopolyspora spinosa including those synthetically derived thereof including various salt forms. The natural spinosyns are often referred to as spinosyn A, spinosyn B, spinosyn C, spinosyn D, spinosyn E etc.

The structure of the spinosyns can be illustrated by the general formula (2A) and (2B)

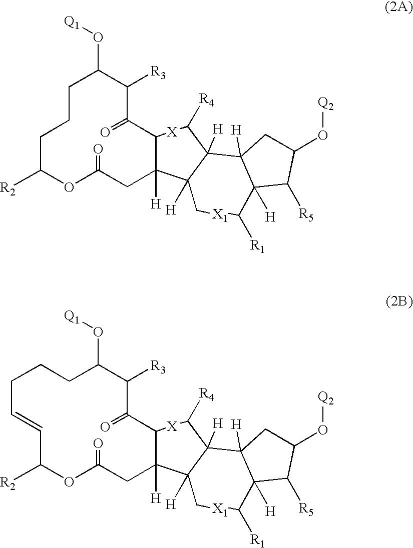

wherein X and X₁ represents a single or double bond or an epoxide unit; Q₁ and Q₂ represents an optionally substituted sugar or aminosugar unit or H; R₁, R₂, R₃ and R₄ represents such substituents as H, alkyl, alkenyl, cycloalkyl, alkylcarbonyl, alkylamino or alkylhydroxylamino, with such groups optionally being substituted with e.g. halogen atoms, hydroxy and alkoxy groups; R₅ represents such groups as H, OH, alkoxy or carbonyl.

Spinosyn compounds are, for example, known from U.S. Pat. No. 5,496,931; U.S. Pat. No. 5,539,089; U.S. Pat. No. 5,670,364 and U.S. Pat. No. 6,001,981 and PCT application nos. WO 97/00265-A1, WO 2002/077004-A1, WO 2002/077005-A1 and WO 2001/019840-A1. The spinosyns are usually mixtures of several major components. A commercially available spinosyn is the compound Spinosad which is a mixture of spinosyn A and spinosyn D. A more recent spinosyn is Spinetoram synthetically prepared from the natural spinosyns, also a mixture of two major components. When appropriate, the spinosyns also include various salt forms thereof.

The compound Piperazine and its salts are known to control e.g. ascarids (large roundworms) and hookworms in animals such as dogs, cats, cattle, horses and poultry. Various salts forms, both mono- and di-salts, include piperazine adipate, piperazine hydrochloride, piperazine sulfate, piperazine citrate and piperazine phosphate.

Among preferred Glutamate- or GABA-gated chloride channel agonist pesticides according to the invention are pesticidal active avermectins, milbemycines and spinosyns. Among preferred avermectins are Abamectin, Aversectin C, Doramectin, Emamectin, Eprinomectin, Ivermectin, Selamectin and salts thereof, and especially selected among Abamectin, Aversectin C, Ivermectin and Emamectin-benzoate with Abamectin being the most preferred choice. Among preferred milbemycines are Milbemectin, Milbemycin oxime, Moxidectin, Lepimectin, Nemadectin and salts thereof. The preferred spinosyns are Spinosad and Spinetoram. For use in crop protection the preferred Glutamate- or GABA-gated chloride channel agonist pesticide is selected among Abamectin, Aversectin C, Emamectin, Milbemectin, Spinosad and Spinetoram and salts thereof, whereas for use in the control of pests in or on humans or animals the preferred pesticide is selected among Abamectin, Doramectin, Emamectin, Eprinomectin, Ivermectin, Selamectin, Milbemycin oxime, Moxidectin, Lepimectin, Nemadectin, Spinosad and piperazine and salts thereof.

It is to be understood that the pesticides useful according to the present invention does not necessarily need to have the Glutamate- or GABA-gated chloride channel agonistic effect as its primary mode of action. Spinosad as an example is believed to have an effect on both the GABA-gated chloride channel as well as targeting the nicotinic acetylcholine receptor (see for example PCT application no. WO 01/70028-A1, especially p. 8, 1. 27). Thus, the primary requirement for a suitable pesticidal compound according to the present invention is that it interferes agonistically with the function of the Glutamate- or GABA-gated chloride channel.

The Glutamate- or GABA-gated chloride channel agonist pesticides according to the invention may be applied in the form of a pharmacologically or agriculturally acceptable salt, analog or combination thereof. Salts of the pesticides may be prepared using standard procedures known to those skilled in the art of synthetic organic chemistry. For example, acid addition salts are prepared from the free base (typically wherein the neutral form of the pesticide has a neutral amino group) using conventional means, involving reaction with a suitable acid. Generally, the base form of the drug is dissolved in an organic solvent such as alcohols, ethers, acetonitrile and the like and the acid is added thereto. The resulting salt either precipitates or may be brought out of solution by addition of a less polar solvent. Suitable acids for preparing acid addition salts include both organic acids, e.g., acetic acid, propionic acid, glycolic acid, pyruvic acid, oxalic acid, malic acid, malonic acid, succinic acid, maleic acid, fumaric acid, tartaric acid, citric acid, benzoic acid, cinnamic acid, mandelic acid, methanesulfonic acid, ethanesulfonic acid, p-toluenesulfonic acid, benzenesulfonic acid, salicylic acid, and the like, as well as inorganic acids, e.g., hydrochloric acid, hydrobromic acid, sulfuric acid, nitric acid, phosphoric acid, and the like. An acid addition salt may be reconverted to the free base by treatment with a suitable base. Preparation of basic salts of acid moieties which may be present (e.g., carboxylic acid groups) are prepared in a similar manner using a pharmaceutically or agriculturally acceptable base such as sodium hydroxide, potassium hydroxide, ammonium hydroxide, calcium hydroxide, magnesium hydroxide, trimethylamine, or the like.

As used herein the term “Vitamin E compound” is meant to include all tocopherol and tocotrienol derivatives and isomers, and salts and esters thereof and analogs thereof, and include α-tocopherol, β-tocopherol, γ-tocopherol, δ-tocopherol, α-tocotrienol, β-tocotrienol, γ-tocotrienol, δ-tocotrinol, as well as acetates and other (alkyl)esters thereof (e.g. tocopherol acetate, also known as tocopheryl acetate), phosphates (e.g. tocopherol phosphate disodium), succinates (e.g. tocopherol succinate) and optionally substituted compounds thereof as well as such analogs as e.g. alpha-tocopheryl nicotinate and Trolox (6-hydroxy-2,5,7,8-tetramethylchroman-2-carboxylic acid). The term also includes the individual compounds (naturally occurring or synthetic prepared) as well as mixtures thereof. Natural Vitamin E exists in eight different forms or isomers, four tocopherols and four tocotrienols as mentioned above. Synthetic Vitamin E usually marked as d,l-tocopherol or d,l tocopheryl acetate, with 50% d-alpha tocopherol moiety and 50% 1-alpha-tocopherol moiety (often refered to as tocopheryl acetate, all-rac alpha). Preferred Vitamin E compounds are tocopherol and tocotrienol and esters and salts thereof such as alkylesters, succinates and phosphates; alpha-tocopheryl nicotinate and Trolox.

By the term “Niacin compound”, is meant nicotinic acid as well as derivatives thereof such as amides, esters, and hydroxynicotinic- and hydroxyisonicotinic-acids and salts thereof and include, by example, niacinamide (nicotinamide), isonicotinic acid, nicotinic acid alkyl esters (e.g. methyl- or ethyl-nicotinacid ester), 6-hydroxy nicotinacid, acipimox, aluminum nicotinate, niceritrol, nicoclonate, nicomol, inositol hexaniacinate and oxiniacic acid. The term also includes the individual compounds (naturally occurring or synthetic prepared) as well as mixtures thereof. Preferred Niacin compounds are optionally hydroxy substituted nicotinic acid and isonicotinic acid and salts and C₁₋₁₂ alkylesters thereof, optionally hydroxy substituted nicotinamide and isonicotinamide and salts thereof.

Use of mixtures of at least one Vitamin E compound and at least one Niacin compound may be applied, but is preferably used as single components with use of at least one Vitamin E compound solely as the component B being most preferred.

The Animals to be treated in accordance with the present invention includes, e.g. domestic animals (livestock and companion). The environs for the animals include farmyard structures, dairy sheds, stables, poultry sheds, pig sties, dog and cat kennels and houses where dogs and cats are kept. Animals on which the compositions can be applied to control pests, e.g. pathogenic endo- and ecto-parasites, include productive animals, breeding animals, zoo animals, pets as well as laboratory and experimental animals, such as mice, rats, guinea-pigs, golden hamsters, dogs, cats, cattle, horses, sheep, pigs, goats, camels, water buffalo, donkeys, rabbits, fallow deer and reindeer, fur-bearing animals such as mink, chinchilla and raccoon, birds such as hens, geese, turkeys and ducks as well as fresh- and salt-water fish. The fish include food fish, cultivated fish, aquarium fish and ornamental fish of all ages which live in fresh water, sea water and pond water. The food fish and cultivated fish include, for example, carp, eel, trout, whitefish, salmon, bream, roach, rudd, chub, flounder, sole, plaice, saithe, wrasse, turbot, halibut, Japanese yellowtail (Seriola quinqueradiata), Japanese eel (Anguilla japonica), red sea bream (Pagurus major), sea bass (Dicentrarchus labrax), grey mullet (Mugilus cephalus), arctic char (Salvelinus alpinus), pompano, gilt-bread sea bream (Sparus auratus), Tilapia spp., chichlid species, such as, for example, plagioscion and channel catfish. The use according to the invention is especially suitable for breeding salmon, i.e. all members of the family of Salmonidae, especially those of the sub-family Salmonini and preferably the following species: Atlantic salmon (Salmon salar), brown or sea trout (Salmon trutta), rainbow trout (Salmon gairdneri); as well as the Pacific salmon (Oncorhynchus): Oncorhynchus gorbuscha, Oncorhynchus keta, Oncorhynchus nekra, Oncorhynchus kisutch, Oncorhynchus tshawytscha and Oncorhynchus mason; also included, however, are the species modified by breeding, e.g. Salmo clarkia.

By controlling the pathogenic endoparasites and ectoparasites the intention is to reduce disease, mortality and reductions in yield, so that the use of the compositions according to the invention enables more economical and simpler animal keeping.

According to the invention, it is possible to treat and protect all plants including parts of plants against agricultural pests. Plants are to be understood as meaning all plants and plant populations such as desired and undesired wild plants or crop plants (including naturally occurring crop plants). Parts of plants are to be understood as meaning all above-ground and below-ground parts and organs of plants, such as shoot, leaf, flower and root, examples which may be mentioned being leaves, needles, stems, trunks, flowers, fruit-bodies, fruits and seeds and also roots, tubers and rhizomes. Parts of plants also include harvested plants and vegetative and generative plant propagation material, for example seedlings, tubers, rhizomes, cuttings and seeds (including stored seeds).

The pesticidal composition of the present invention may be used for the protection of beneficial crops against agricultural pests, such crops include cereals, such as wheat, barley, rye, oats, rice, maize and sorghum; beet, such as sugar beet and fodder beet; fruit, e.g. pomes, stone fruit and soft fruit, such as apples, pears, plums, peaches, almonds, cherries and berries, e.g. strawberries, raspberries and blackberries; leguminous plants, such as beans, lentils, peas and soybeans; oil plants, such as rape, mustard, poppy, olives, sunflowers, coconut, castor oil, cocoa and groundnuts; cucurbitaceae, such as marrows, cucumbers and melons; fibre plants, such as cotton, flax, hemp and jute; citrus fruits, such as oranges, lemons, grapefruit and mandarins; vegetables, such as spinach, lettuce, asparagus, cabbages, carrots, onions, tomatoes, potatoes and paprika; lauraceae, such as avocado, cinnamon and camphor, and tobacco, nuts, coffee, aubergines, sugar cane, tea, pepper, vines, hops, bananas, natural rubber plants and ornamentals; as well as seeds of such crops. Within the scope of this invention such crops and seeds further comprise those that are resistant, either by transgenic means or selected by classical means, to pesticidal active ingredients and/or those that are resistant to certain pests, for example Bacillus thuringiensis (Bt) pest-resistant crops.

By the term “pest” as used herein is meant invertebrates such as insects, nematodes, trematodes, crustaceans and arachnids.

The compositions according to the invention have a good plant tolerance and favorable toxicity toward warm blooded animals and are suitable for combating human and animal pests, in particular insects, arachnids and nematodes, particularly preferably for combating pests, and their development stages, which occur in agriculture, in forests, in the protection of stored products, including plant seeds, and materials and from the hygiene sector, as well as for protection of humans and animals against endo- and ecto-parasites, with use in agriculture and animal health being most preferred. They are active against normally sensitive and resistant types and against all or individual development stages. The abovementioned pests include:

From the order of the Isopoda, for example Oniscus asellus, Armadillidium vulgare and Porcellio scaber. From the order of the Diplopoda, for example Blaniulus guttulatus. From the order of the Chilopoda, for example Geophilus carpophagus and Scutigera spp. From the order of the Symphyla, for example Scutigerella immaculata. From the order of the Thysanura, for example Lepisma saccharina. From the order of the Collembola, for example Onychiurus armatus. From the order of the Orthoptera, for example Blatta orientalis, Periplaneta americana, Leucophaea maderae, Blatella germanica, Acheta domesticus, Gryllotalpa spp., Locusta migratoria migratorioides, Melanoplus differentialis and Schistocerca gregaria. From the order of the Astigmata, for example Otodectus cynotis and Notoedres cati. From the order of the Dermaptera, for example Forficula auricularia. From the order of the Isoptera, for example Reticulitermes spp. From the order of the Anoplura, for example Phylloera vastatrix, Pemphigus spp., Pediculus humanus corporis, Solenopotes spp., Pthirus spp., Haematopinus spp. and Linognathus spp. From the order of the Mallophaga, for example Trimenopon spp., Menopon spp., Ecomenacanthus spp., Menacanthus spp., Trichodectes spp., Felicola spp., Damalinea spp., and Bovicola spp. From the order of the Thysanoptera, for example Hercinothrips femoralis and Thrips tabaci. From the order of the Heteroptera, for example Eurygaster spp., Dysdercus intermedius, Piesma quadratum, Cimex lectularius, Rhodnius prolixus and Triatoma spp. From the order of the Hemiptera, for example Aleurodes brassicae, Bemisia tabaci, Trialeurodes vaporariorum, Aphis gossypii, Brevicoryne brassicae, Cryptomyzus ribis, Doralis fabae, Doralis pomi, Dysdercus cingulatus, Eriosoma Lanigerum, Hyalopterus arundinis, Macrosiphum avenae, Myzus spp., Phorodon humuli, Rhopalosiphum padi, Empoasca spp., Euscelus bilobatus, Nephotettix cincticeps, Lecanium corni, Saissetia oleae, Laodelphax striatellus, Nilaparvala lugens, Aonidiella aurantii, Aspidiolus hederae, Pseudococcus spp. and Psylla spp. From the order of the Lepidoptera, for example Pectinophora gossypiella, Bupalus piniarius, Chematobia brumata, Lithocolletis blancardella, Hyponomeuta padella, Plutella maculipennis, Malacosoma neustria, Euproctis chrysorrhoea, Lymantria spp., Bucculatrix thurberiella, Phyllocnistis citrella, Agrotis spp., Euxoa spp., Feltia spp., Earias insulana, Heliothis spp., Laphygma exigua, Mamestra brassicae, Panolis flammea, Prodenia litura, Spodoptera spp., Trichoplusia ni, Carpocapsa pomonella, Pieris spp., Chilo spp., Pyrausta nubilialis, Ephestia kuehniella, Galleria mellonella, Cacoecia podana, Capua reticulana, Choristoneura fumiferana, Clysia ambiguella, Homona magnanima and Tortrix viridana. From the order of the Coleoptera, for example Anobium punctatum, Rhizopertha dominica, Bruchidius obtectus, Acanthoscelides obtectus, Hylotrupes bajulus, Agelastica alni, Leptinotarsa decemlineata, Phaedon cochleariae, Diabrotica spp., Psylliodes chrysocephala, Epilachna varivestis, Atomaria spp., Oryzaephilus surinamensis, Anthonomus spp., Sitophilus spp., Otiorrhynchus sulcatus, Cosmopolites sordidus, Ceuthorrhynchus assimilis, Hypera postica, Dermestes spp., Trogoderma spp., Anthrenus spp., Attagenus spp., Lyctus spp., Meligethes aeneus, Ptinus spp., Niptus hololeucus, Gibbium psylloides, Tribolium spp., Tenebrio molitor, Agriotes spp., Conoderus spp., Melolontha melolontha, Amphimallon solstitialis and Costelytra zealandica. From the order of the Hymenoptera, for example Camponotus spp., Diprion spp., Formicidae spp., Hoplocampa spp. Lasius spp., Myrmecia spp., Solenopsis spp. and Vespa spp. From the order of the Diptera, for example Aedes spp., Anopheles spp., Auchmeromyia spp., Cordylobia spp., Cochliomyia spp., Chrysops spp., Culex spp., Glossina spp., Drosophila melanogaster, Musca spp., Fannia spp., Calliphora erythrocephala, Lucilia spp., Chrysomyia spp., Cuterebra spp., Gasterophilus spp., Hypobosca spp., Stomoxys spp., Oestrus spp., Oesteromyia spp., Oedemagena spp., Hydrotaca spp., Muscina spp., Haematobosca spp., Haematobia spp., Hypoderma spp., Rhinoestrus spp., Melophagus spp., Hippobosca spp., Sarcophaga spp., Wohlfartia spp., Tabanus spp., Tannia spp., Bibio hortulanus, Oscinella frit, Phorbia spp., Pegomyia hyoscyami, Ceratitis capitata, Dacus oleae and Tipula paludosa. From the order of the Siphonaptera, for example Xenopsylla cheopis, Ctenocephalides spp., Echidnophaga spp. and Ceratophyllus spp. From the class of the Arachnida, for example Araneae spp., Amblyomma spp., Boophilus spp., Demodex spp., Hyalomma spp., Ixodes spp., Sarcoptidae spp., Psoroptidac spp., Rhipicephalus spp. and Dermacentor spp. From the order Phthiraptera, for example the families Boopidae, Haematopinidae, Hoplopleuridae, Linognathidae, Menoponidae, Pediculidae, Philopteridae, and Trichodectidae.

The pathogenic endoparasites include nematodes and Acantocephala, in particular: From the subclass of the Monogenea, e.g. Gyrodactylus spp., Dactylogyrus spp., Polystoma spp. From the order of the Enoplida e.g.: Trichuris spp., Capillaria spp., Trichomosoides spp., Trichinella spp. From the order of the Rhabditia e.g.: Micronema spp., Strongyloides spp. From the order of the Strongylida e.g.: Stronylus spp., Triodontophorus spp., Oesophagodontus spp., Trichonema spp., Gyalocephalus spp., Cylindropharynx spp., Poteriostomum spp., Cyclococercus spp., Cylicostephanus spp., Oesophagostomum spp., Chabertia spp., Stephanurus spp., Ancylostoma spp., Uncinaria spp., Bunostomum spp., Globocephalus spp., Syngamus spp., Cyathostoma spp., Metastrongylus spp., Dictyocaulus spp., Muellerius spp., Geigeria spp., Protostrongylus spp., Neostrongylus spp., Cystocaulus spp., Pneumostrongylus spp., Spicocaulus spp., Elaphostrongylus spp., Parelaphostrongylus spp., Crenosoma spp., Paracrenosoma spp., Angiostrongylus spp., Aelurostrongylus spp., Filaroides spp., Parafilaroides spp., Trichostrongylus spp., Haemonchus spp., Ostertagia spp., Marshallagia spp., Cooperia spp., Nematodirus spp., Hyostrongylus spp., Obeliscoides spp., Amidostomum spp., Ollulanus spp. From the order of the Oxyurida e.g.: Oxyuris spp., Enterobius spp., Passalurus spp., Syphacia spp., Aspiculuris spp., Heterakis spp. From the order of the Ascaridia e.g.: Ascaris spp., Toxascaris spp., Toxocara spp., Parascaris spp., Anisakis spp., Ascaridia spp. From the order of the Spirurida e.g.: Dirofilaria spp., Onchocerca spp., Wuchereria spp., Gnathostoma spp., Physaloptera spp., Thelazia spp., Gongylonema spp., Habronema spp., Parabronema spp., Draschia spp., Dracunculus spp., Parafilaria spp., Brugia spp. From the order of the Filariida e.g.: Stephanofilaria spp., Litomosoides spp. From the order of Gigantorhynchida e.g.: Filicollis spp., Moniliformis spp., Macracanthorhynchus spp., Prosthenorchis spp.

Combinations of at least one compound A with the at least one compound B are particularly suitable for use against pests from the genera Aculus, Alabama, Anticarsia, Hemisia, Choristoneura, Epilachna, Frankliniella, Laspeyresia, Leptinotarsa, Liriomyza, Lymantria, Keiferia, Panonchus, Phtorimaca, Phyllocnistis, Phyllocoptruta, Pieris, Plutella, Polyphagotarsonemus, Pseudoplusia, Psylla, Sciryhothrips, Spodoptera, Tetranychus, Trialeurodes, Trichoplusia, for example in cotton, soya, vegetable, fruit, citrus, wine and maize crops.

It is also possible to control various types of spider mites, such as the fruit tree spider mite (Panonychus ulmi), the citrus spider mite (Panonychus citri) and the common spider mite (Tetranychus urticae); and false spider mites such as Brevipalpus mites (e.g. Brevipalpus chilensis).

Combinations of at least one compound A with the at least one compound B are particularly suitable for use against human and animal pests from the genera: Ancylostoma (e.g. A. braziliens, A. caninum, A. duodenale, A. martinezi, A. tubaeforme), Angiostrongylus (e.g. A. cantonensis, A. chabaudi, A. daskalovi, A. dujardini, A. sciuri, A. vasorum), Anoplocephala (e.g. A. magna, A. perfoliata), Archeostrongylus (A. italicus), Ascaridia (e.g. A. alectoris, A. columbae, A. compar, A. cylindrica, A. dissimilis, A. galli, A. lineata, A. magnipapilla, A. numidae, A. perspicillum), Ascaris (e.g. A. castoris, A. lumbricoides, A. mosgovoyi, A. ovis, A. spalacis, A. suum), Boophilus (e.g. B. annulatus, B. microplus), Bovicola (e.g. B. alpinus, B bovis, B. caprae, B. limbatus, B. longicornis, B. ovis, B. tarandi, B. tibialis), Brugia (e.g. B. malayi), Bunostomum (e.g. B. phlebotomum, B. trigonocephalum), Caligus (e.g. C. lacustris), Capillaria (e.g. C. aerophila, C. hepatica, C. philippinensis), Chabertia (e.g. C. ovina), Chorioptes (e.g. C. bovis), Cooperia (e.g. C. asamati, C. bisonis, C. curticei, C. mcmasteri, C. oncophora, C. pectinata, C. punctata, C. surnabada, C. zurnabada), Coronocyclus (e.g. C. coronatus, C. labiatus, C. labratus, C. sagittatus), Craterostomum (e.g. C. acuticaudatum), Ctenocephalides (e.g. C. canis, C. felis), Cyathostomum (e.g. C. alveatum, C. catinatum, C. pateratum, C. tetracanthum), Cylicocyclus (e.g. C. adersi, C. auriculatus, C. ashworthi, C. brevicapsulatus, C. elongatus, C. insigne, C. leptostomum, C. nassatus, C. radiatus, C. triramosus, C. ultrajectinus), Cylicodontophorus (e.g. C. bicoronatus), Cylicostephanus (e.g. C. asymetricus, C. bidentatus, C. calicatus, C. goldi, C. hybridus, C. longibursatus, C. minutus, C. poculatus), Damalinia (e.g. D. bovis), Demodex (e.g. D. brevis, D. canis, D. folliculorum, D. gatoi), Dictyocaulus (e.g. D. arnfieldi, D. capreolus, D. capreolus, D. eckerti, D. filarial, D. murmanensis, D. noerneri, D. viviparus), Dipylidium (e.g. D. caninum, D. oerleyi, D. porimamillanum, D. sexcoronatum), Dirofilaria (e.g. D. immitis, D. repens, D. ursi), Echinococcus (e.g. E. granulosus, E. multilocularis), Fasciola (e.g F. gigantica, F. hepatica), Felicola (e.g. F. inaequalis, F. subrostratus), Gaigeria (e.g. G. pachyscelis), Gastrophilus (e.g. G. haemorrhoidalis, G. inermis, G. intestinalis, G. nasalis, G. nigricornis, G. pecorum), Gyalocephalus (e.g. G. capitatus), Habronema (e.g. H. majus, H. microstoma, H. muscae), Haematobia (e.g. H. irritans, H. titillans), Haematopinus (e.g. H. apri, H. asini, H. eurysternus, H. suis, H. tuberculatus), Haemonchus (e.g. H. contortus, H. placei), Heterakis (e.g., H. altaica, H. crexi, H. dispar, H. gallinarum, H. isolonche, H. macroura, H. monticelliana, H. spumosa, H. tenuicauda, H. vesicularis), Hyostrongylus (e.g. H. rubidus), Hypoderma (e.g. H. actaeon, H. bovis, H. diana, H. lineatum, H. tarandi), Knemidokoptes (e.g. K. laevis, K. mutans), Linognathus (e.g. L. africanus, L. ovillus, L. pedalis, L. setosus, L. stenopsis, L. vituli), Lucilia (e.g. L. ampullacea, L. bufonivora, L. caesar, L. cuprina, L. illustris, L. magnicornis, L. pilosiventris, L. regalis, L. richardsi, L. sericata, L. silvarum), Mesocestoides (e.g. M. alaudae, M. ambiguus, M. angustatus, M. canislagopodis, M. imbutiformis, M. leptothylacus, M. lineatus, M. litteratus, M. melesi, M. perlatus, M. petroli, M. Zacharovae), Metastrongylus (e.g. M. apri, M. asymmetricus, M. confusus, M. elongatus, M. pudendotectus, M. pulmonalis, M. salmi), Nematodirus (e.g. N. abnormalis, N. aspinosus, N. battus, N. chabaudi, N. davtiani, N. europaeus, N. filicollis, N. helvetianus, N. hugonnetae, N. ibicis, N. lanceolatus, N. oiratianus, N. roscidus, N. rupicaprae, N. skrjabini, N. spathiger), Notoedres (e.g. N. cati), Oesophagostomum (e.g. O. bifurcum, O. cervi, O. columbianum, O. dentatum, O. longicaudum, O. quadrispinulatum, O. radiatum, O. sikae, O. venulosum), Oestrus (e.g. O. caucasicus, O. ovis), Onchocerca (e.g. O. cervicalis, O. flexuosa, O. garmsi, O. gutturosa, O. jakutensis, O. lienalis, O. lupi, O. reticulate, O. skrjabini, O. volvulus), Ostertagia (e.g. O. antipini, O. arctica, O. buriatica, O. circumcinta, O. dahurica, O. drozdzi, O. gruehneri, O. kolchida, O. lasensis, O. leptospicularis, O. lyrata, O. mossi, O. murmani, O. nemorhaedi, O. orloffi, O. ostertagi, O. skrjabini, O. trifurcata, O. volgaensis), Otodectes (e.g. O. cynotis), Oxyuris (e.g. O. acutissima, O. equi, O. flagellum, O. paradoxa), Paranoplocephala (e.g. P. mamillana), Parapoteriostomum (e.g. P. euproctus, P. mettami), Parascaris (e.g. P. equorom), Petrovinema (e.g. P. skijabini, P. poculatum), Poteriostomum (e.g. P. imparidentatum, P. ratzii), Protostrongylus (e.g. P. brevispiculatum, P. commutatus, P. cuniculorum, P. hobmaieri, P. kamenskyi, P. muraschkinzewi, P. pulmonalis, P. raillieti, P. rufescens, P. rupicaprae, P. tauricus, P. terminalis), Psoroptes (e.g. P. bovis, P. ovis), Sarcoptes (e.g. S. scabiel), Solenopotes (e.g. S. burmeisteri, S. capillatus, S. caprioli, S. tarandi), Stephanurus (e.g. S. dentatus), Strongyloides (e.g. S. avium, S. bufonis, S. canis, S. darevskyi, S. martis, S. mascomai, S. mirzai. S. mustelorum, S. myopotami, S. natricis, S. ophiusensis, S. papillosus, S. putorii, S. rasomi, S. ratti, S. rostombekowi, S. spiralis, S. stercoralis, S. suis, S. turkmenica, S. vulpis, S. westeri), Strongylus (e.g. S. edentatus, S. equinus, S. vulgaris), Taenia (e.g. T. brauni, T. cervi, T. crassiceps, T. endothoracica, T. hydatigena, T. krabbei, T. krepkogorski, T. laticollis, T. martis, T. multiceps, T. mustelae, T. ovis, T. parenchymatosa, T. parva, T. parviuncinata, T. pisiformis, T. polyacantha, T. rilevi, T. saginata, T. secunda, T. serialis, T. smythi, T. solium, T. taeniaeformis), Thelazia (e.g T. callipaeda, T. cholodkowskii, T. gulosa, T. lacrymalis, T. papillosa, T. rhodesi, T. skrjabini), Toxascaris (e.g. T. leonina), Toxocara (e.g. T. canis, T. cati, T. mystax), Trichodectes (e.g. T. canis, T. melis, T. pingui), Trichostrongylus (e.g. T. andreevi, T. askivali, T. axei, T. brevis, T. calcaratus, T. capricola, T. colubrifommis, T. lerouxi, T. longispicularis, T. medius, T. ostertagiaeformis, T. pietersei, T. probolurus, T. retotaeformis, T. skrjabini, T. suis, T. tenuis, T. ventricosus, T. vitrinus), Trichuris (e.g. T. arvicolae, T. capreoli, T. cervicaprae, T. discolor, T. globulosa, T. guevarai, T. infundibulus, T. lani, T. leporis, T. muris, T. myocastoris, T. opaca, T. ovis, T. skrjabini, T. spalacis, T. suis, T. sylvilagi, T. tarandi, T. trichiura, T. vulpis), Triodontophorus (e.g. T. brevicauda, T. brochotrilobulatus, T. minor, T. nipponicus, T. serratus, T. tenuicollis), Uncinaria (e.g. U. criniformis, U. stenocephala) and Wuchereria (e.g. W. bancrofti).

As part of the animal kingdom are fish, and combinations of at least one compound A with the at least one compound B are also suitable for use for combating fish parasites, and in particular fish-parasitising crustaceans. Among these are the Copepodae (cyclops; fish-lice) with the genera Ergasilus, Bromolochus, Chondracaushus, Caligus (e.g. C. curtus, C. elongatus, C. orientalis, C. teres, C. labaracis), Lepeophtheirus (e.g. L. salmonis, L. cuneifer, L. pectoralis, L. hippoglssus), Elythrophora, Dichelestinum, Lamproglenz, Hatschekia, Legosphilus, Symphodus, Ceudrolasus, Pseudocycmus, Lernaea, Lernaeocera, Pennella, Achthares, Basanistes, Salmincola, Brachiella, Epibrachiella, Pseudotracheliastes, and the families Ergasilidae, Bromolochidae, Chondracanthidae, Calijidae, Dichelestiidae, Gyrodactylidae (e.g Gyrodactylus spp. such as Gyrodactylus cotti, Gyrodactylus salaries, Gyrodactylus truttae), Philichthyidae, Pseudocycnidae, Lernaeidae, Lernaepodidae, Sphyriidae, Cecropidae, as well as the Branchiuriae (carp lice) with the families Argulidae and the genera Argulus spec, as well as the Cirripediae and Ceratothoa gaudichaudii.

A pronounced effect of the Glutamate- or GABA-gated chloride channel agonist pesticides when used in combination with the at least one compound B is the increased knock-down-effect on pests when exposed to combination products according to the invention (i.e. the pests are rapidly paralyzed) which is highly beneficial in pest control. Even those pests which may not receive a lethal dose through a very brief contact will, nevertheless, be sufficiently immobilized long enough for them to become either easy prey to predators, such as birds, or to suffer death by desiccation.

Compositions containing the compound(s) A and the compound(s) B may be employed in any conventional form, for example, in the form of a twin pack, or as an emulsifiable concentrate, an oil-in-water emulsion, soluble concentrate, suspension concentrate, microemulsion, wettable powder, ready-to-spray solution, soluble granule, water-dispersible granule, creams, soaps, waxes, tablets or pour-on-formulations. Such compositions can be formulated using adjuvants and formulation techniques that are known in the art for individually formulating the compounds A and B. For example, the compounds A and B may be mixed together, optionally with other formulating ingredients.

The compositions may contain a diluent, which may be added during the formulation process, after the formulation process (e.g. by the user—a farmer or custom applicator), or both. The term diluent includes all liquid and solid agriculturally or pharmaceutically (including veterinary medicines) acceptable material-including carriers which may be added to the compound A or compound B to bring them in a suitable application or commercial form.

Examples of suitable solid diluents or carriers are aluminium silicate, talc, calcined magnesia, kieselguhr, tricalcium phosphate, powdered cork, absorbent carbon black, chalk silica, and clays such as kaolin and bentonite. Examples of suitable liquid diluents used alone or in combination include water, organic solvents (e.g. acetophenone, cyclohexanone, isophorone, toluene, xylene, petroleum distillates, pyrrolidones, alcohols, glycols, amines, acids and esters), and mineral, animal, and vegetable oils as well as derivatives thereof such as fatty alcohols, fatty acids and ester thereof. The compositions may also contain surfactants, protective colloids, thickeners, penetrating agents, stabilizers, sequestering agents, anti-caking agents, coloring agents, corrosion inhibitors, and dispersants such as lignosulfite waste liquors and methylcellulose. The term surfactant, as used herein, means an agriculturally or pharmaceutically acceptable material which imparts emulsifiability, stability, spreading, wetting, dispersibility or other surface-modifying properties. Examples of suitable surfactants include non-ionic, anionic, cationic and ampholytic types such as lignin sulfonates, fatty acid sulfonates (e.g. lauryl sulfonate), the condensation product of formaldehyde with naphthalene sulfonate, alkylarylsulfonates, ethoxylated alkylphenols, and ethoxylated fatty alcohols. Other known surfactants that have been used with insecticides, acaricides, nematicides or pharmaceuticals (including veterinary medicines) are also acceptable.

When mixed with additional components, the composition typically contains about 0.001 to about 90% by weight of compound(s) A and about 0.001 to about 90% by weight of compound(s) B, about 0 to about 30% agriculturally/pharmaceutically acceptable surfactants, and about 10 to 99.99% solid or liquid diluents. The compositions may additionally contain other additives known in the art, such as pigments, thickeners and the like.

The compositions may be applied in various combinations of the compound(s) A and compound(s) B. For example, they may be applied as a single “ready-mix” form, or in a combined spray mixture composed from separate formulations of the compounds A and B, e.g. a “tank-mix” form. Thus, to be used in combination, it is not necessary that the compound(s) A and B, be applied in a physically combined form, or even at the same time, i.e. the compounds may be applied in a separately and/or sequentially application, provided that the application of the second compound occurs within a reasonable period of time from the application of the first compound. The combination effect results so long as the compounds A and B are present at the same time, regardless of when they were applied. Thus, for instance, a physical combination of the compounds could be applied, or one could be applied earlier than the other so long as the earlier-applied ingredient is still present on the pest to be controlled, on the plant or in the soil surrounding the plant infested or susceptible of being infested with the pest to be controlled when the second ingredient is applied, and so long as the weight ratio of available ingredients A and B falls within that disclosed and claimed herein. The order of applying the individual compounds A and B is not essential.

Rates of application of the composition will vary according to prevailing conditions such as targeted pests, degree of infestation, weather conditions, soil conditions, plant species to be treated, animal to be treated, mode of application, and application time. Compositions containing the compounds A and B may be applied in the manner which they are formulated, as discussed above. For example, they may be applied as sprays, such as water-dispersible concentrates, wettable powders, water-dispersible granules or as creams, soaps, waxes, tablets, solutions and pour-on-formulations. The compositions may also be applied topically, orally, by stomach intubation or by injection, especially when applied on domestic animals such as sheep, pigs, cattle, horses, goats, dogs, cats and poultry for the control of internal and/or external harmful pests. Solutions for use on the skin are trickled on, spread on, rubbed in, sprinkled on or sprayed on. Pour-on formulations are poured or sprayed onto limited areas of the skin and penetrating the skin and acting systemically. Gels are applied to or spread on the skin or introduced into body cavities. Oral solutions are administered directly or following a prior dilution to the use concentration.

The treatment of plants and parts of plants according to the invention may be carried out directly or by action on their environment (e.g soil application), habitat or storage area according to customary treatment methods, for example by dipping, spraying, evaporating, atomizing, broadcasting, brushing-on and, in the case of propagation material, in particular in the case of seeds, furthermore by one- or multi-layer coating.

The treatment of fish is effected either orally, for example via the feed, or by balneotherapy, for example a “medical bath” into which the fish are placed and in which they are kept for a period (minutes to several hours), for example in association with being moved from one rearing pool to another. In particular cases, the treatment can also be effected parenterally, for example by injection. Transient or permanent treatment may also take place of the habitat of the fish, for example in net cages, entire pond installations, aquaria, tanks or pools, in which the fish are kept.

The pesticidal composition may be obtained by replacing any amount of a pesticide with the synergist as long as the synergistic action is achieved, i.e. the pesticidal action of the composition is higher than the sum of pesticidal effects of each of the pesticide and the synergist when taken alone. In a preferred aspect of the invention between 5% and 97% by weight of pesticide is replaced by a synergistic amount of the synergist. For most pesticides the highest synergistic action is obtained by replacing between 20% and 90% by weight of pesticide by a synergistic amount of the synergist.

The weight ratio of compound(s) A to compound(s) B is selected to provide a synergistic pesticidal action, i.e. the compound(s) B is present in an activity enhancing amount with respect to compound(s) A. In general, the weight ratio of A:B ranges from about 20:1 to about 1:30, preferably 10:1 to 1:20, more preferably from about 1:1 to about 1:15, and even more preferably from about 1:1 to about 1:10. In particular are those ratios preferred where the compound(s) B is in excess of the compound(s) A, e.g. ranges from about 1:1.1 to about 1:30, more preferably from about 1:1.1 to about 1:15, and even more preferably from about 1:1.1 to about 1:10. In a certain aspect the weight ratio of A:B ranges from about 1:5 to 1:24, more preferably 1:6 to 1:20.

The weight ratio of A:B will depend on various factors such as the chemical nature of A and B, the mode of application, the harmful pests to be combated, the useful plant to be protected, the animal infested with harmful pests, the application time, etc.

An effective amount of compound(s) A and compound(s) B is any amount that has the ability to combat the harmful pests, e.g. an amount which is sufficient to cause a measurable reduction in the exposed pest population. When used in crop protection, e.g. by direct or soil application, effective aggregate combined amounts of the compounds A and B range from about 0.01 to about 2000 g/ha, preferably 0.1 to 1500 g/ha, more preferably 1-1000 g/ha, even more preferably 2-800 g/ha, and most preferably 2-200 g/ha. In the treatment of seeds, effective aggregate combined amounts of the compounds A and B range between 0.001 and 20 g per kilogram of seed, preferably between 0.01 and 10 g per kilogram of seed.

When used in treatment of animals or humans against pests effective aggregate combined amounts of the compounds A and B range from about 0.01 to 1000 mg pr kg of animal or human bodyweight, preferably 0.1 to 100 mg pr kg of animal or human bodyweight.

Suitable combinations of pesticide and synergist comprise:
Abamectin and a Vitamin E compound. The Vitamin E compound may be selected among e.g. tocopheryl acetate, alpha-tocopheryl acetate, (+) alpha-tocopheryl nicotinate, Trolox, (+) delta-tocopherol, (+) alpha-tocopheryl succinate, (+) alpha-tocopheryl acetate, (+) alpha-tocopherol, or tocopherol. The pesticide and the synergist are preferably used in weight proportions of 2:1 to 1:10, more preferred 1:1.1 to 1:5. This combination is suited for combating pest on plants, such as Spodoptera exigua larvae, Tetranychus urticae larvae, Tetranychus urticae mites, or the nymphs of Dysdercus cingulatus. Further pests which may be combated include Psylla pyri, Plutella xylostella, Tetranychus urticae, Panonychus citri, Brevipalpus chilensis.
Abamectin and a Niacin compound. The Niacin compound may be selected among e.g. nicotinamide, nicotinic acid, isonicotinic acid, (+) alpha-tocopheryl nicotinate, methyl nicotinate, ethyl nicotinate. The pesticide and the synergist are preferably used in weight proportions of 20:1 to 1:30, preferably 5:1 to 1:5. This combination is suited for combating pest on plants, such as the larvae Spodoptera exiqua, housefly, and the nymphs of Dysdercus cingulatus.
Ivermectin and a Vitamin E compound (e.g. tocopherol and tocopheryl acatate). The pesticide and the synergist are preferably used in weight proportions of 2:1 to 1:20, more preferred 1:1.1 to 1:15. This combination is suited for combating pest on plants, such as nymphs of Dysdercus cingulatus and Onchocerca lienalis.
Emamectin (e.g. the benzoate salt thereof) and a Vitamin E compound (e.g. tocopheryl acetate or tocopherol). The pesticide and the synergist are preferably used in weight proportions of 2:1 to 1:30, more preferred 1:1.1 to 1:15. This combination is suited for combating pest on plants, such as the larvae Spodoptera exiqua, and Plutella xylostella and animal pests such as Lepeophtheirus salmonis.
Aversectin C and a Vitamin E compound (e.g. tocopheryl acetate or tocopherol). The pesticide and the synergist are preferably used in weight proportions of 20:1 to 1:30, preferably 5:1 to 1:5. This combination is suited for combating pest on plants, such as the mite Tetranychus urticae.
Spinosad and a Vitamin E compound (e.g. tocopheryl acetate or tocopherol). The pesticide and the synergist are preferably used in weight proportions of 20:1 to 1:30, preferably 5:1 to 1:20. This combination may be utilized for combating pest on plants, such as Tetranychus urticae mites or the larvae of Lucilia cuprina (sheep blowfly).
Milbemectin and a Vitamin E compound (e.g. tocopheryl acetate or tocopherol). The pesticide and the synergist are preferably used in weight proportions of 2:1 to 1:30, more preferred 1:2 to 1:15.
Doramectin and a Vitamin E compound (e.g. tocopheryl acetate, (+) alpha-tocopherol, or tocopherol). The pesticide and the synergist are preferably used in weight proportions of 2:1 to 1:30, more preferred 1:2 to 1:15. This combination is suited for combating animal pests, such as T. colubriformis, T. circumcincta or H. contortus larvae.
Selamectin and a Vitamin E compound (e.g. tocopheryl acetate, (+) alpha-tocopherol, or tocopherol). The pesticide and the synergist are preferably used in weight proportions of 2:1 to 1:30, more preferred 1:2 to 1:15. This combination is suited for combating cat fleas (Ctenocephalides felis felis) in larvae as well as the adult stage.

Additional insecticides, acaricides and nematicides may also be added to the pesticidal composition provided that the additional insecticide/acaricide/nematicide does not interfere in a negative way with the synergistic relationship between the compounds A and B. The presence of the compound(s) B may also enhance the activity of such additional active ingredient(s). An additional insecticide, acaricide or nematicide may be utilized if broadening of the spectrum of control or preventing the build-up of resistance is desired. Suitable examples of such additional active compounds are: acephate, acetamiprid, acrinathrin, alanycarb, albendazole, aldicarb, alphamethrin, amitraz, azadirachtin, azinphos, azocyclotin, Bacillus thuringiensis, bendiocarb, benfuracarb, bensultap, bephenium, betacyfluthrin, bifenazate, bifenthrin, bistrifluoron, BPMC, brofenprox, bromophos, brotianide, bufencarb, buprofezin, butamisole, butocarboxin, butylpyridaben, cadusafos, cambendazole, carbaryl, carbofuran, carbophenothion, carbosulfan, cartap, chloethocarb, chloroethoxyfos, chlorfenapyr, chlorofenvinphos, chlorofluazuron, chloromephos, chlorpyrifos, chromafenozide, cis-resmethrin, clocythrin, clofentezine, clorsulon, closantel, clothianidin, cyanophos, cycloprothrin, cyfluthrin, cyhalothrin, cyhexatin, cypermethrin, cyromazine, deltamethrin, demeton, diamphenethide, dibromosalan, dichlorophen, difenthiuron, diazinon, dichlofenthion, dichlorvos, dicliphos, dicrotophos, diethion, diethylcarbamazine, diflubenzuron, dimethoate, dimethylvinphos, dinotefuran, dioxathion, disulfoton, edifenphos, epsiprantel, esfenvalerate, ethiofencarb, ethion, ethiprole, ethofenprox, ethoprophos, etoxazole, etrimphos,

febantel, fenamiphos, fenbendazole, fenzaquin, fenbutatin oxide, fenitrothion, fenobucarb, fenothiocarb, fenoxycarb, fenpropathrin, fenpyrad, fenpyroximate, fenthion, fenvalerate, fipronil, flonicamid, fluazinam, fluazuron, flubendazole, flucycloxuron, flucythrinate, flufenoxuron, flufenprox, fluvalinate, fonophos, formothion, fosthiazate, fubfenprox, furathiocarb, gamma-cyhalothrin, haloxon, heptenophos, hexaflumuron, hexachlorophene, hexythiazox, imidacloprid, indoxacarb, iprobenfos, isazophos, isofenphos, isoprocarb, isoxathion, lambda-cyhalothrin, levamisole, lufenuron, malathion, mebendazole, mecarbam, mevinphos, mesulfenphos, metaldehyde, methacrifos, methamidophos, methidathion, methiocarb, methomyl, methoxyfenozide, methyridine, metolcarb, milbemectin, monocrotophos, morantel, naled, netobimin, niclopholan, niclosamide, nitenpyram, nitroxynil, omethoate, oxamyl, oxfendazole, oxibendazole, oxyclozanide, oxydemethon M, oxydeprofos, parathion A, parathion M, parbendazol, permethrin, phenothiazine, phenthoate, phorate, phosalone, phosmet, phosphamidon, phoxim, pirimicarb, pirimiphos, praziquantel, profenofos, promecarb, propaphos, propoxur, prothiofos, prothoate, pymetrozin, pyrachlophos, pyrantel, pyridaphenthion, pyresmethrin, pyrethrum, pyridaben, pyrimidifen, pyriproxifen, quinalphos, rafoxanide, rynaxypyr, salithion, sebufos, silafluofen, spirodiclofen, spirotetratmat, sulfotep, sulprofos, tebufenozid, tebufenpyrad, tebupirimiphos, teflubenzuron, tefluthrin, temephos, terbam, terbufos, tetrachlorvinphos, tetramisole, thenium, thiabendazole, thiacloprid, thiafenox, thiamethoxam thiodicarb, thiofanox, thiomethon, thionazin, thiophanate, thuringiensin, tralomethrin, triarathen, triazophos, triazuron, trichlorfon, triclabendazole, triflumuron, trimethacarb, vamidothion, XMC, xylylcarb, zetamethrin.

Further, inclusion of other known active compounds, such as herbicides, fungicides, fertilisers or growth regulators, is also possible.

The additional ingredients used for the compositions in addition to the compounds A and the compounds B should be selected in order to avoid inadvertent reaction to the animal being treated such as skin irritation etc. The skilled person will appreciate how selecting suitable ingredients for such compositions. Such compositions will typically comprise a solvent or a carrier. It is preferred that the composition does not comprise a pyrrolidone solvent in combination with a solvent selected from the group consisting of diethylene glycol monobutyl ether, benzyl benzoate, isopropyl alcohol and xylenes. The compositions may further comprise a colorant, which facilitates application of the compositions on the animals since the person applying the compositions easily can see where the composition already has been applied.

The ingredients used for veterinary or pharmaceutical compositions in addition to the compounds A and the compounds B should be pharmaceutically acceptable or acceptable according to veterinary standards as the skilled person within the area will appreciate. Such compositions will typically comprise a solvent or a carrier. It is preferred that the composition does not comprise a pyrrolidone solvent in combination with a solvent selected from the group consisting of diethylene glycol monobutyl ether, benzyl benzoate, isopropyl alcohol and xylenes. In an aspect of the invention, when the pesticide agent is Ivermectin and the synergist is Vitamin E, then the composition is not part of a nutritive composition.

Generally speaking, a synergistic effect exists whenever the action of a combination of two chemicals is greater than the sum of the action of each of the chemicals alone. Therefore, a synergistic combination is a combination of chemical components having an action that is greater than the sum of the action of each chemical component alone, and a synergistically effective amount is an effective amount of a synergistic combination. Synergism can involve either 2 pesticides, or one pesticide plus a substance that is not by itself toxic to the pest, and such a substance is termed a synergist, i.e. a chemical that enhances the toxicity of a pesticide to a pest.

Well-known methods for determining whether synergy exists include the Colby method, the Tammes method and the Wadley method, all of which are described below. Any one of these methods may be used to determine if synergy exists between the compounds A and B. In the Colby method, also referred to as the Limpels method, the action to be expected E for a given active ingredient combination obeys the so-called Colby formula. According to Colby, the expected action of ingredients A+B using p+q ppm of active ingredient is:

$$E = X + Y - \frac{X \cdot Y}{100}$$

where ppm=milligrams of active ingredient (=a.i.) per liter of spray mixture X=% action by component A using p ppm of active ingredient Y=% action by component B using q ppm of active ingredient. If the ratio R defined as the action actually observed (O) divided by the expected action (E) is >1 then the action of the combination is superadditive, i.e. there is a synergistic effect. For a more detailed description of the Colby formula, see Colby, S. R. “Calculating synergistic and antagonistic responses of herbicide combination,” Weeds, Vol. 15, pages 20-22; 1967; see also Limpel et al., Proc. NEWCC 16: 48-53 (1962).

The Tammes method uses a graphic representation to determine whether a synergistic effect exists. See “Isoboles, a graphic representation of synergism in pesticides,” Netherlands Journal of Plant Pathology, 70 (1964) p. 73-80.

The Wadley method is based on comparison of an observed ED50 value (i.e. dose of a given compound or combination of compounds providing 50% pest control) obtained from experimental data using the dose response curves and an expected ED50 calculated theoretically from the formula:

$$ED 50 {( A + B )}_{exp} = \frac{a + b}{\frac{a}{ED 50 {( A )}_{obs}} + \frac{b}{ED 50 {( B )}_{obs}}}$$

wherein a and b are the weight ratios of compound A and B in the mixture and ED50_{obs} is the experimentally determined ED50 value obtained using the dose response curves for the individual compounds. The ratio ED50(A+B)_{expected}/ED50(A+B)_{observed} expresses the factor of interaction (F) (synergy factor). In case of synergism, F is >1. The same formula applies when LD50 values are used, i.e. lethal dose, as well as EC50 values, i.e. effective concentration, and LC50 values, i.e. lethal concentration. For a more detailed description of the Wadley method, see Levi et al., EPPO-Bulletin 16, 1986, 651-657.

An alternative approach as mentioned by D. L. Richer (Pesticide Science, 1987, 19, 309-315, especially p. 313) to determine synergy is based on purely observed values rather than observed and theoretical calculated values as used in the previously mentioned methods. In this alternative method the effect of a given rate of the mixture A and B is compared with the effect of the same rate of each of A and B used alone. If synergism exists, the observed effect of the mixture will be greater than the observed effect of either component used alone:

E_{obs}(xA+yB)>E_{obs}(x+y)A, and >E_{obs}(x+y)B

wherein x and y are the quantities of A and B in the mixture.

The documents specifically cited in the description are incorporated by reference into the description. The invention is illustrated by the following examples, which are provided for illustratory purposes and should not be construed as limiting for the invention:

### EXAMPLES

### Example 1

The efficacy of an Abamectin 18 g/l emulsifiable concentrate formulation (EC) was tested on Spodoptera exiqua larvae on Tradescani crassifolia leaves. The test on Spodoptera exigua was done as a dip-test where Tradescani crassifolia leaves were dipped in the various test solutions and dried. Afterwards, each leaf was infested with 5 Spodoptera exigua larvae. The effect was evaluated after 72 hours and a dose response curve was constructed to obtain the LC50 of each treatment.

Besides testing the commercial Abamectin 18 g/l EC formulation, Abamectin 18 g/l EC formulation containing either 20 g/l or 60 g/l tocopheryl acetate, all-rac alpha, Ph. Eur. 5^{th} Ed., a blank EC formulation, i.e. without Abamectin, and a blank EC formulation containing 60 g/l tocopheryl acetate, all-rac alpha, Ph. Eur. 5^{th} Ed., were included in the test as well.

TABLE 1
Calculated LC50 values (total ppm Abamectin and tocopheryl acetate
in the dip solutions) are shown for the Abamectin EC test on
Spodoptera exiqua larvae on Tradescani crassifolia leaves.

| Formulation | LC50_{obs} (ppm) | LC50ₑₓₚ (ppm) | F (exp/obs) |
|---|---|---|---|
| Abamectin 18 g/l EC | 38.65 | | |
| Abamectin 18 g/l EC + | 34.45 | 78.2 | 2.27 |
| 20 g/l tocopheryl acetate | (16.32 ppm Abamectin + | | |
| | 18.13 ppm Tocopheryl acetate) | | |
| Abamectin 18 g/l EC + | 27.65 | 148.4 | 5.37 |
| 60 g/l tocopheryl acetate | (6.38 ppm Abamectin + | | |
| | 21.27 ppm Tocopheryl acetate) | | |
| Blank EC | >1000 | | |
| Blank EC + | >1000 | | |
| 60 g/l tocopheryl acetate | | | |

From the Abamectin 18 g/l EC and the tocopheryl acetate 60 g/l LC50 values expected LC50 values were calculated according to Wadley's formula. The corresponding F-values in the above table show a synergistic insecticidal effect of Abamectin and tocopheryl acetate on the Spodoptera exiqua larvae for both mixtures.

### Example 2

The efficacy of experimental Abamectin 18 g/l oil-in-water formulations (EW) was tested on Spodoptera exiqua larvae on Tradescani crassifolia leaves. A mixture of methylated fatty acid and octanol was applied as solvent for the Abamectin in the EW formulation.

The test on Spodoptera exigua was as described in example 1. The effect was evaluated after 72 hours and a dose response curve was constructed to obtain the LC50 of each treatment.

Besides testing the Abamectin 18 g/l EW formulation, Abamectin 18 g/l EW formulations containing either 20 g/l or 60 g/l tocopheryl acetate, all-rac alpha, Ph. Eur. 5^{th} Ed., and an 18 g/l tocopheryl acetate EW without Abamectin, were tested as well.

TABLE 2
Calculated LC50 values (total ppm Abamectin and tocopheryl acetate in
the dip solutions) are shown for the Abamectin EW test on
Spodoptera exiqua larvae on Tradescani crassifolia leaves.

| Formulation | LC50_{obs} (ppm) | LC50ₑₓₚ (ppm) | F(exp/obs) |
|---|---|---|---|
| Abamectin 18 g/l EW | 64.67 | | |
| Abamectin 18 g/l EW + | 15.64 | 79.4 | 5.08 |
| 20 g/l tocopheryl acetate | (7.41 ppm Abamectin + 8.23 ppm | | |
| | tocopheryl acetate) | | |
| Abamectin 18 g/l EW + | 17.98 | 88.8 | 4.94 |
| 60 g/l tocopheryl acetate | (4.15 ppm Abamectin + | | |
| | 13.83 ppm tocopheryl acetate) | | |
| Blank EW + | >100 | | |
| 18 g/l tocopheryl acetate | | | |

From the observed LC50 values for Abamectin 18 g/l EW and tocopheryl acetate 18 g/l EW expected LC50 values for the mixtures were calculated according to Wadley's formula. The corresponding F-values in the above table show a synergistic insecticidal effect of Abamectin and tocopheryl acetate on the Spodoptera exiqua larvae for both mixtures.

### Example 3

Dilutions of experimental Abamectin EW formulations with diethyl phthalate as solvent for the active ingredient were sprayed on bean plants (Vicia faba) in a spray cabinet and mites (Tetranychus urticae) were transferred to the plants after the leaf surfaces were dry. The degree of leaf damage was evaluated 7 days after the mites were placed on the plants, and ED50 values (g Abamectin and tocopheryl acetate/ha) were calculated for the Abamectin EW formulations tested, table 3. The ED50 values are based on % leaf damage.

TABLE 3
Calculated ED50 (g Abamectin and tocopheryl acetate/ha) for the
Abamectin EW formulation test on Tetranychus urticae on
Vicia faba. ED50 values are based on % leaf damage.

| | | ED50ₑₓₚ (g | F |
|---|---|---|---|
| Formulation | ED50_{obs} (g AI/ha) | AI/ha) | (exp/obs) |
| Abamectin 18 g/l EW | 3.73 | | |
| Abamectin 18 g/l EW + | 1.31 | 7.5 | 5.72 |
| 20 g/l tocopheryl acetate | (0.62 g Abamectin + | | |
| | 0.69 g tocopheryl | | |
| | acetate) | | |
| Abamectin 18 g/l EW + | 4.68 | 14.0 | 2.99 |
| 60 g/l tocopheryl acetate | (1.08 g Abamectin + | | |
| | 3.6 g tocopheryl | | |
| | acetate) | | |
| Blank EW + | 79.4 | | |
| 18 g/l tocopheryl acetate | | | |

From the observed ED50 values for Abamectin 18 g/l EW and tocopheryl acetate 18 g/l EW expected ED50 values for the mixtures were calculated according to Wadley's formula. The corresponding F-values in the above table show a synergistic insecticidal effect of Abamectin and tocopheryl acetate on Tetranychus urticae for both mixtures.

### Example 4

A range of Abamectin solutions in acetone was prepared. Similarly, a range of tocopherol, all-rac alpha, solutions in acetone was prepared. Abamectin solution (2 μl), tocopherol solution (2 μl) or both were applied topically on nymphs of Dysdercus cingulatus. Abamectin was applied dorsally while tocopherol was applied ventrally. Acetone alone (4 μl) was applied to control nymphs in order to ensure that the acetone did not contribute to the mortality. The mortality of the nymphs was recorded 24 h after applying the solutions. The observed and the expected results, according to the Colby-method, are tabulated below.

TABLE 4
Observed and expected mortality for a mixture of Abamectin and
tocopherol solutions in acetone, on Dysdercus cingulatus nymphs.
Abamectin was applied dorsally and tocopherol ventrally.

| | % Mortality | Observed | Expected | |
|---|---|---|---|---|
| Applied on each | for each | mortality | mortality | |
| nymph | ingredient | (%) | (%) | R (obs/exp) |
| 2000 ng Abamectin | 74 | 100 | 74 | 1.35 |
| 2000 ng tocopherol | 0 | | | |

According to table 4, the observed mortality was higher than the expected mortality for mixtures of Abamectin and tocopherol applied topically on nymphs of Dysdercus cingulatus. The superadditive effect was achieved although Abamectin was applied dorsally and tocopherol ventrally.

### Example 5

A range of Abamectin solutions in acetone was prepared. Similarly, a range of tocopherol, all-rac alpha, solutions was prepared. Mixed solutions of Abamectin and tocopherol in acetone were prepared as well. Nymphs of Dysdercus cingulatus were treated topically with either an Abamectin acetone solution (2 μl), a tocopherol acetone solution (2 μl) or mixed solutions (2 μl). The Dysdercus cingulatus mortality was recorded 48 h after applying the products. It was ensured that application of acetone alone (2 μl) did not affect the nymph mortality.

Log dose-mortality curves were constructed for the Abamectin and the tocopherol treatments. LD50 values based on the sum of Abamectin and tocopherol contents (ng active ingredient(s) per nymph) were calculated. The results are shown in table 5.

TABLE 5
LD50 values (ng active ingredient(s) per nymph) for Abamectin,
tocopherol and for mixtures of Abamectin and tocopherol.
Mortality results on Dysdercus cingulatus were recorded
48 h after applying the ingredients.

| | | LD50ₑₓₚ | |
|---|---|---|---|
| | LD50_{obs} | (ng AI(s) per | F |
| Treatment | (ng AI(s) per nymph) | nymph) | (exp/obs) |
| Abamectin | 1595 | | |
| Abamectin + | 1226 | 2954 | 2.41 |
| tocopherol (1:1) | (613 ng of each AI) | | |
| Tocopherol | >20,000 ng tocopherol | | |

From the observed LD50 values for Abamectin and tocopherol expected LD50 values for the mixtures were calculated according to Wadley's formula. The corresponding F-value in the above table shows a synergistic insecticidal effect of Abamectin and tocopherol on Dysdercus cingulatus nymphs for the mixture.

### Example 6

A range of Ivermectin solutions in acetone was prepared. Similarly, a range of tocopherol solutions was prepared. Mixed solutions of Ivermectin and tocopherol in acetone were prepared as well. Nymphs of Dysdercus cingulatus were treated topically with either an Ivermectin acetone solution (2 μl), a tocopherol acetone solution (2 μl) or mixed solutions (2 μl). Control nymphs were treated with 2 μl acetone to ensure that the acetone did not affect the mortality.

The mortality was recorded after 24 and 48 h. The results are tabulated below. The results were evaluated by the Colby-method.

TABLE 6
Observed and expected mortality for combinations of Ivermectin and
tocopherol solutions in acetone on Dysdercus cingulatus nymphs.

| | | | | |
|---|---|---|---|---|
| | Mortality (%) | Observed | Expected | |
| | for each | mortality | mortality | R |
| Applied per nymph | ingredient | (%) | (%) | (obs/exp) |

After 24 h

| | | | | |
|---|---|---|---|---|
| 300 ng Ivermectin | 63 | 70 | 63 | 1.11 |
| 300 ng tocopherol | 0 | | | |
| 100 ng Ivermectin | 33 | 45 | 33 | 1.36 |
| 100 ng tocopherol | 0 | | | |
| 30 ng Ivermectin | 8 | 20 | 8 | 2.50 |
| 30 ng tocopherol | 0 | | | |

After 48 h

| | | | | |
|---|---|---|---|---|
| 300 ng Ivermectin | 86 | 100 | 86 | 1.16 |
| 300 ng tocopherol | 0 | | | |
| 100 ng Ivermectin | 65 | 75 | 65 | 1.15 |
| 100 ng tocopherol | 0 | | | |
| 30 ng Ivermectin | 27 | 35 | 27 | 1.30 |
| 30 ng tocopherol | 0 | | | |

According to table 6, the observed mortality was higher than the expected mortality (Colby method). The corresponding R-values show that Ivermectin and tocopherol exerted a synergistic effect on the Dysdercus cingulatus nymphs.

### Example 7

A range of Abamectin solutions in acetone was prepared. Similarly, a range of nicotinamide solutions was prepared. Mixed solutions of Abamectin and nicotinamide in acetone were prepared as well. Nymphs of Dysdercus cingulatus were treated topically with either an Abamectin acetone solution (2 μl), a nicotinamide acetone solution (2 μl) or mixed solutions (2 μl). It was ensured that application of acetone (2 μl) did not affect the nymph mortality.

The Dysdercus cingulatus mortality was recorded 48 h after applying the products. Log dose-mortality curves were constructed for the Abamectin, the nicotinamide and for the mixed solutions. The LD50 values reflect the sum of Abamectin and nicotinamide (active ingredients) present at LD50.

TABLE 7
LD50 values (ng active ingredient(s) per nymph) for Abamectin,
nicotinamide and for mixtures of Abamectin and nicotinamide.
The mortality results on Dysdercus cingulatus were
recorded 48 h after applying the ingredients.

| | LD50_{obs} | LD50ₑₓₚ | |
|---|---|---|---|
| | (ng AI(s) per | (ng AI(s) per | |
| Treatment | nymph) | nymph) | F (exp/obs) |
| Abamectin | 126 | | |
| Abamectin + | 108.9 | 251.0 | 2.31 |
| nicotinamide (1:1) | (54 ng of each) | | |
| nicotinamide | >20,000 | | |

From the observed LD50 values for Abamectin and nicotinamide expected LD50 values for the mixtures were calculated according to Wadley's formula. According to the observed LD50 values shown in table 7, nicotinamide had a low activity against the nymphs. However, when the nicotinamide was applied together with Abamectin, the two compounds exerted a synergistic activity on the Dysdercus cingulatus nymphs as seen by the above F-value.

### Example 8

The efficacy of an Abamectin 18 g/l emulsifiable concentrate formulation (EC) was tested on Spodoptera exiqua larvae on Tradescani crassifolia leaves. The test on Spodoptera exigua was done as a dip-test where Tradescani crassifolia leaves were dipped in the various tests solutions and dried. Afterwards, each leaf was infested with 5 Spodoptera exigua larvae.

Besides testing the Abamectin 18 g/l EC formulation, Abamectin 18 g/l EC formulation was tested together with 4.5 g/l and 72 g/l nicotinamide. An EC formulation comprising nicotinamide was included in the test as well. The observed mortalities are tabulated in table 8.

TABLE 8
Expected and observed mortality for combinations of Abamectin
and nicotinamide on Spodoptera exigua larvae in a
Tradescani crassifolia dip test.

| Concentration of ingredients | Observed mortality | |
|---|---|---|
| in tests solutions | (%) | R (obs/exp) |
| 10 ppm Abamectin | 10 | |
| 7.5 ppm Abamectin | 45 | 4.5 |
| 2.5 ppm nicotinamide | | |
| 2.5 ppm Abamectin | 15 | 1.5 |
| 7.5 ppm nicotinamide | | |
| 10 ppm nicotinamide | 0 | |

The strongest toxin of the mixture in table 8 is Abamectin. Comparing the effect of the mixture of Abamectin and nicotinamide with the effect of Abamectin in the same dose as the total content of active; Abamectin+nicotinamide in the mixture it is seen that the effect of the mix is greater than the single component treatment with Abamectin. Applying the alternative approach as described previously, the results in table 8 show that Abamectin and nicotinamide exerted a synergistic action on Spodoptera exigua larvae.

### Example 9

A range of Emamectin-benzoate and tocopherol, all-rac alpha, solutions with varying concentrations of each compound in acetone was prepared. Mixed solutions of Emamectin-benzoate and tocopherol, all-rac alpha, were also prepared. Larvae of Spodoptera exiqua were treated topically with either an Emamectin-benzoate acetone solution (1 μl), a tocopherol acetone solution (1 μl) or a solution containing both of the two compounds in the ratios 1:1 and 1:3 (1 μl). Log dose-mortality curves were constructed for the Emamectin-benzoate solutions, the tocopherol solutions and the mixtures. The mortality was recorded 48 h after applying the products and an LD50 value was calculated. A comparison was made between the actual observed LD50 and the expected value, based on the Wadley method as described previously. The results of the Spodoptera exiqua test are shown in the table below.

TABLE 9
LD50 values for Emamectin-benzoate (EMA), tocopherol (TOCO)
and mixtures thereof in test on Spodoptera exiqua.

| | LD50_{obs} | LD50ₑₓₚ | |
|---|---|---|---|
| Treatment | [ng AI(s)/larvae] | [ng AI(s)/larvae] | F (exp/obs) |
| EMA | 4.30 | | |
| EMA + TOCO (1:1) | 7.90 | 8.6 | 1.09 |
| | (3.95 ng EMA + | | |
| | 3.95 ng TOCO) | | |
| EMA + TOCO (1:3) | 12.20 | 17.2 | 1.41 |
| | (3.05 ng EMA + | | |
| | 9.15 ng TOCO) | | |
| TOCO | >20000 | | |

According to the observed LD50 values shown in table 9, tocopherol had a low activity against the larvae. However, when the tocopherol was applied together with Emamectin benzoate, the two compounds exerted a synergistic activity on the Spodoptera exiqua as seen from the above F-values.

### Example 10

The efficacy of an experimental Aversectin C 18 g/l oil-in-water formulation (EW) was tested on Tetranychus urticae on bean plant leaves (Vicia faba). A mixture of methylated fatty acid and octanol was applied as solvent for the Aversectin C in the EW formulation. A similar formulation containing tocopheryl acetate, all-rac alpha, Ph. Eur. 5^{th} Ed., was prepared. Dilutions of the Aversectin C EW, the tocopheryl acetate EW and mixtures of the two formulations in ratios 1:3, 1:1 and 3:1 were sprayed on bean plants in a spray cabinet and mites (Tetranychus urticae) were transferred to the plants after the leaf surfaces were dry. The degree of leaf damage was evaluated 7 days after the mites were placed on the plants, and ED50 values (g/ha) were calculated for the formulations and mixtures tested, see table below. The ED50 values are based on % leaf damage.

TABLE 10
Calculated ED50 (g active ingredient(s)/ha) for the Aversectin
C EW (AVE C), the tocopherol acetate EW (TOCO A) and
mixtures of the two formulations in ratios 1:3, 1:1 and
3:1 in test on Tetranychus urticae mites on Vicia faba.
ED50 values are based on % leaf damage.

| | ED50_{obs} | ED50ₑₓₚ | |
|---|---|---|---|
| Formulation | (g AI/ha) | (g AI/ha) | F (exp/obs) |
| AVE C | 2.50 | | |
| AVE C + | 1.50 | 3.3 | 2.20 |
| TOCO A (3:1) | (1.13 g AVE C + 0.38 g | | |
| | TOCO A) | | |
| AVE C + | 2.00 | 4.8 | 2.42 |
| TOCO A (1:1) | (1 g AVE C + 1 g TOCO A) | | |
| AVE C + | 3.80 | 9.1 | 2.40 |
| TOCO A (1:3) | (0.95 g AVE C + 2.85 g | | |
| | TOCO A) | | |
| TOCO A | 79.40 | | |

From the observed ED50 values for Aversectin C 18 g/l EW and tocopheryl acetate 18 g/l EW expected ED50 values for the mixtures were calculated according to Wadley's formula The corresponding F-values in the above table show a synergistic insecticidal effect of Aversectin C and tocopheryl acetate on Tetranychus urticae for all mixtures tested.

### Example 11

Abamectin, Ivermectin and tocopherol solutions in acetone were prepared. Mixed solutions of either Abamectin or Ivermectin and tocopherol were also prepared. Nymphs of Dysdercus cingulatus were treated topically with Abamectin acetone solution (20,000 ng/nymph), Ivermectin acetone solution (20,000 ng/nymph), a tocopherol acetone solution (20,000 ng/nymph) or a solution containing Abamectin and tocopherol or Ivermectin and tocopherol in the ratio 1:3 (20,000 ng total/nymph). The solutions were applied dorsally on the nymphs.

The Dysdercus cingulatus mortality was followed over time and recorded. Log time-mortality curves were constructed for the Abamectin and Ivermectin solutions and for the mixtures with tocopherol. An LT50 value was calculated for each application. The results of the Dysdercus cingulatus test are shown in the table below.

TABLE 11
LT50 values for Abamectin, Ivermectin and their mixtures with
tocopherol in the ratio 1:3. In total, 20,000 ng/nymph was applied.
The results are based on two replicates, each consisting
of ten Dysdercus cingulatus nymphs.

| Treatment | LT50 (h) |
|---|---|
| Abamectin | 5.3 |
| Abamectin + tocopherol (1:3) | 4.7 |
| Ivermectin | 9.1 |
| Ivermectin + tocopherol (1:3) | 6.4 |

Nymphs treated with 20,000 ng tocopherol did not die during the 24 h test period. It is seen that the LT50 value are smaller for the combined treatments, i.e. Abamectin+tocopherol as well as Ivermectin+tocopherol, than for the treatments with Abamectin or Ivermectin alone, thus an improvement in knock-down effect is observed especially taken into consideration, that each nymph treated with the combination only received 5,000 ng Abamectin or Ivermectin respectively while nymphs treated with either Avermectin or Ivermectin alone received 20,000 ng active ingredient.

### Example 12

The efficacy of an experimental Abamectin 18 g/l oil-in-water formulation (EW) was tested on Tetranychus urticae on bean plant leaves (Vicia faba). A mixture of methylated fatty acid and octanol was applied as solvent for the Abamectin in the EW formulation. Besides testing the Abamectin 18 g/l EW formulation, Abamectin 18 g/l EW formulations containing a range of tocopheryl acetate, all-rac alpha, Ph. Eur. 5^{th} Ed., concentrations were tested as well. Dilutions of the formulations were sprayed on bean plants in a spray cabinet and mites (Tetranychus urticae) were transferred to the plants after the leaf surfaces were dry. The degree of leaf damage was evaluated 7 days after the mites were placed on the plants, and ED50 values (g/ha) were calculated for the formulations and mixtures tested, see table below. The ED50 values are based on % leaf damage.

TABLE 12
Calculated ED50 (g/ha) for the experimental Abamectin (ABA)
EW formulations containing tocopheryl acetate (TOCO A)
in test on Tetranychus urticae mites on Vicia faba.
ED50 values are based on % leaf damage.

| | ED50_{obs} | ED50ₑₓₚ | |
|---|---|---|---|
| Formulation | (g AI/ha) | (g AI/ha) | F (exp/obs) |
| ABA | 0.71 | | |
| ABA + TOCO A (1:5) | 2.64 | 4.3 | 1.61 |
| | (0.44 g ABA + 2.2 g | | |
| | TOCO A) | | |
| ABA + TOCO A (1:9) | 4.00 | 7.1 | 1.77 |
| | (0.40 g ABA + 3.6 g | | |
| | TOCO A) | | |
| TOCO A | 79.4 | | |

From the observed ED50 values for Abamectin 18 g/l EW and tocopheryl acetate 18 g/l EW, expected ED50 values for the mixtures were calculated according to Wadley's formula. The corresponding F-values in the above table show a synergistic insecticidal effect of Abamectin and tocopheryl acetate on Tetranychus urticae for the two mixtures tested.

### Example 13

Dilutions of a Spinosad suspension concentrate, an 18 g/l EW formulation containing tocopheryl acetate, all-rac alpha, Ph. Eur. 5^{th} Ed., and mixtures of the two formulations were sprayed on bean plants (Vicia faba) in a spray cabinet and mites (Tetranychus urticae) were transferred to the plants after the leaf surfaces were dry. Treatments with 100 g ai/ha and 300 g ai/ha were used in this experiment. The degree of leaf damage was evaluated 7 days after the mites were placed on the plants and the percentage of the leaf protected by the treatment is shown in table 13.

TABLE 13
The table shows % leaf protection for the Spinosad and tocopheryl
acetate test on Tetranychus urticae on Vicia faba.
Two different doses have been applied; 100 g ai/ha and 300 g
ai/ha and the values are averages based on four evaluations.

| Applied active on leaf (g/ha) | % protection | R (obs/exp) |
|---|---|---|
| 100 g/ha Spinosad | 5 | |
| 75 g/ha Spinosad | 35 | 2.33-7.00 |
| 25 g/ha tocopheryl acetate | | |
| 50 g/ha Spinosad | 17.5 | 1.17-3.50 |
| 50 g/ha tocopheryl acetate | | |
| 25 g/ha Spinosad | 50 | 3.33-10.00 |
| 75 g/ha tocopheryl acetate | | |
| 100 g/ha tocopheryl acetate | 15 | |
| 300 g/ha Spinosad | 5 | |
| 225 g/ha Spinosad | 60 | 6.86-12.00 |
| 75 g/ha tocopheryl acetate | | |
| 150 g/ha Spinosad | 62.5 | 7.14-12.50 |
| 150 g/ha tocopheryl acetate | | |
| 75 g/ha Spinosad | 55 | 6.29-11.00 |
| 225 g/ha tocopheryl acetate | | |
| 300 g/ha tocopheryl acetate | 8.8 | |

Using the alternative method for determining synergism the effect of each mixture of Spinosad and tocopheryl acetate is compared with the effect of the same rate of each of the active ingredients used alone. Since both Spinosad and tocopheryl acetate has an effect the R-values are calculated as a range using the effect of both actives. As can be seen in the above table synergism exists, since the observed effect of each mixture is greater than the observed effect of either component used alone on Tetranychus urticae.

### Example 14

The efficacy of Abamectin 18 g/l oil in water formulations (EW) was tested in field trials. A mixture of methylated fatty acid and octanol was applied as solvent for the Abamectin in the EW formulation. Besides testing the above-mentioned EW formulation, an Abamectin 18 g/l EW formulation containing 80 g/l tocopheryl acetate, all-rac alpha, Ph. Eur. 5^{th} Ed. was tested as well. A mixture of methylated fatty acid and octanol was also applied as solvent for the Abamectin in this formulation.

The results of the trials are tabulated below. In the table the relative potency of the two formulations are given for the trials made.

TABLE 14
Relative potency of Abamectin 18 g/l EW containing 80 g/l tocopheryl
acetate, all-rac alpha and Abamectin 18 g/l EW without tocopheryl acetate

| | | Relative Potency |
|---|---|---|
| Pest | Crop | Aba EW with tocopheryl aceate vs. Aba EW |
| Psylla pyri | Pear | 1.17:1 |
| Plutella | Cabbage | 1.69:1 |
| xylostella | | |
| Plutella | Brocoli | 2.52:1 |
| xylostella | | |
| Tetranychus | Okra | 1.41:1 |
| urticae | | |
| Tetranychus | Strawberry | 1.07:1 |
| urticae | | |
| Tetranychus | Tomato | 1.76:1 |
| urticae | | |
| Panonychus | Orange | 1.63:1 |
| citri | | |

According to the test results in table 14, the Abamectin EW formulation containing 80 g/l tocopheryl acetate, all-rac alpha, Ph. Eur. 5^{th} Ed., was more active against pests than the Abamectin EW formulation without tocopheryl acetate.

### Example 15

The Abamectin 18 g/l EW formulation containing 80 g/l tocopheryl acetate, all-rac alpha, Ph. Eur. 5^{th} Ed., described in example 14, was compared with traditional Abamectin 18 g/l EC formulation in field trials.

The results of the trials are given in table 15. The relative potencies of the two formulations tested are tabulated.

TABLE 15
Relative potency of Abamectin 18 g/l EW containing 80 g/l tocopheryl
acetate, all-rac alpha and Abamectin 18 g/l EC without tocopheryl acetate

| | | Relative Potency |
|---|---|---|
| Pest | Crop | Aba EW with tocopheryl aceate vs. Aba EC |
| Psylla pyri | Pear I | 1.23:1 |
| Psylla pyri | Pear II | 1.09:1 |
| Plutella | Brocoli | 1.79:1 |
| xylostella | | |
| Tetranychus | Okra | 1.12:1 |
| urticae | | |
| Tetranychus | Tomato I | 1.10:1 |
| urticae | | |
| Tetranychus | Tomato II | 1.13:1 |
| urticae | | |
| Tetranychus | Strawberry | 3.16:1 |
| urticae | | |
| Panonychus | Orange | 3.10:1 |
| citri | | |
| Panonychus | Lemon | 2.1:1 |
| citri | | |
| Brevipalpus | Vine I | 1.04:1 |
| chilensis | | |
| Brevipalpus | Vine II | 1.12:1 |
| chilensis | | |

According to the test results in table 15, the Abamectin 18 g/l EW formulation containing 80 g/l tocopheryl acetate, all-rac alpha, Ph. Eur. 5^{th} Ed., was more potent, i.e. more active, against pests than the Abamectin EC formulation without tocopheryl acetate.

### Example 16

In a field trial the activity of an Emamectin benzoate 17 g/l EC formulation was compared with the activity of Emamectin benzoate 17 g/l EC formulations containing either 68 g/l or 136 g/l tocopheryl acetate, all-rac alpha, Ph. Eur. 5^{th} Ed. The results of the trial are shown in table 16. The relative potency of the formulations tested is tabulated.

TABLE 16
Relative potency of Emamectin benzoate (Ema) 17 g/l EC
without tocopheryl aceate, with 68 g/l tocopheryl acetate
and with 136 g/l tocopheryl acetate, respectively.

| Pest | Crop | Relative Potency |
|---|---|---|
| Plutella xylostella | Brocoli | Ema EC containing 68 g/l tocopheryl |
| | | acetate vs Ema EC |
| | | 3.0:1 |
| Plutella xylostella | Brocoli | Ema EC containing 136 g/l tocopheryl |
| | | acetate vs Ema EC |
| | | 3.8:1 |

According to the test results in table 16, the Emamectin benzoate 17 g/l EC formulations containing tocopheryl acetate, all-rac alpha, Ph. Eur. 5^{th} Ed., were more potent, i.e. more active, against the pest than the Emamectin benzoate EC formulation without tocopheryl acetate was. It appears that the more tocopheryl acetate present in the formulation the more potent the formulation.

### Example 17

Dilutions of a 10 g/l Milbemectin EC formulation as well as dilutions of a mixture of 10 g/l Milbemectin EC and tocopheryl aceate, all-rac alpha, Ph. Eur. 5^{th} Ed. (mixture ratio Milbemectin:tocopheryl acetate 1:3, based on weight) were sprayed on bean plants (Vicia fabia) in a spray cabinet and mites (Tetranychus urticae) were transferred to the plants after the leaf surfaces were dry. The degree of leaf damage was recorded 7 days after the mites were placed on the plants, and ED50 values (g Milbemectin and tocopheryl acetate/ha) were calculated for the Milbemectin formulations tested, table 17. The ED50 values are based on % leaf damage.

TABLE 17
Calculated ED50 (g Milbemectin and tocopheryl acetate/ha) for the
Milbemectin formulations tested on Tetranychus urticae on Vicia fabia.
ED50 values are based on % leaf damage.

| | | ED50ₑₓₚ | |
|---|---|---|---|
| Formulation | ED50_{obs} (g ai/ha) | (g ai/ha) | F (exp/obs) |
| Milbemectin 10 g/l EC | 1.52 | — | — |
| Milbemectin 10 g/l EC + | 4.00 | 5.74 | 1.44 |
| 30 g/l tocopherylacetate | | | |
| Blank EW + | >100 | — | — |
| 80 g/l tocopheryl acetate | | | |

From the observed and expected ED50 values the corresponding F value was calculated as shown in table 17. The calculated F value indicates a synergistic activity of Milbemectin and tocopheryl acetate was present.

### Example 18

Various solutions of Vitamin E derivatives, Abamectin and combinations of Vitamin E derivatives and Abamectin were applied dorsally on houseflies. On each housefly 2 μl test solution was applied. The mortality of the treatments was recorded. The mortality results were analysed according to Colby. The synergistic activity of Abamectin and various Vitamin E derivatives on houseflies is illustrated in table 18.

TABLE 18
According to Colby, the ratios between expected and observed
mortality are shown for combinations of Abamectin and
Vitamin E derivatives on houseflies

| Vitamin E derivative | R (obs mortality/exp mortality) |
|---|---|
| (+)alpha-tocopheryl acetate | 1.9 |
| Cas no 58-95-7 | |
| Trolox | 1.3 |
| Cas no 53188-07-1 | |
| (+)alpha-tocopheryl nicotinate | 3.0 |
| Cas no 51898-34-1 | |
| (+)alpha-tocopherol | 2.0 |
| Cas no 59-02-9 | |

According to table 18, a synergistic activity of Abamectin and the tested Vitamin E derivatives was present.

### Example 19

Various solutions of Vitamin E derivatives, Abamectin and combinations of Vitamin E derivatives and Abamectin were applied dorsally on nymphs of Dysdercus cingulatus. On each Dysdercus cingulatus 2 μl test solution was applied. The mortality of the treatments was recorded. The mortality results were analysed according to Colby. The synergistic activity of Abamectin and various Vitamin E derivatives on Dysdercus cingulatus is illustrated in table 19.

TABLE 19
According to Colby, the ratios between expected and observed
mortality are shown for combinations of Abamectin and
Vitamin E derivatives on Dysdercus cingulatus.

| Vitamin E derivative | R (obs mortality/exp mortality) |
|---|---|
| (+)alpha-tocopheryl acetate | 1.2 |
| Cas no 58-95-7 | |
| (+)delta-tocopherol | 1.6 |
| Cas no 119-13-1 | |
| (+)alpha-tocopheryl succinate | 1.3 |
| Cas no 4345-03-3 | |
| (+)alpha-tocopheryl nicotinate | 1.2 |
| Cas no 51898-34-1 | |
| (+)alpha-tocopherol | 1.1 |
| Cas no 59-02-9 | |

According to table 19, a synergistic activity of Abamectin and the tested Vitamin E derivatives was present on nymphs of Dysdercus cingulatus.

### Example 20

Solutions of nicotinamide, Abamectin and combinations of nicotinamide and Abamectin were applied dorsally on houseflies. On each housefly 2 μl test solution was applied. The mortality of the treatments was recorded. The mortality results were analysed according to Colby. The synergistic activity of Abamectin and nicotinamide on houseflies is illustrated in table 20.

TABLE 20
According to Colby, the ratios between expected and observed
mortality are shown for combinations of Abamectin and
nicotinamide on houseflies.

| Treatment | R (obs mortality/exp mortality) |
|---|---|
| Nicotinamide and Abamectin | 1.3 |

According to the Colby method and table 20, synergistic action of nicotinamide and Abamectin was present on houseflies.

### Example 21

Various solutions of nicotinic acid derivatives, Abamectin and combinations of nicotinic acid derivatives and Abamectin were applied dorsally on houseflies. On each housefly 2 μl test solution was applied. The mortality of the treatments was recorded. The mortality results were analysed according to Colby. The synergistic activity of Abamectin and the nicotinic acid derivatives on houseflies is illustrated in table 21.

TABLE 21
According to Colby, the ratios between expected and observed
mortality are shown for combinations of Abamectin and
nicotinic acid derivatives on houseflies.

| Nicotinic acid derivative | R (obs mortality/exp mortality) |
|---|---|
| Nicotinic acid | 1.4 |
| Isonicotinic acid | >2 |
| (+)alpha-tocopheryl nicotinate | 3.0 |
| Methyl nicotinate | 3.0 |
| Ethyl nicotinate | 1.4 |

According to table 21, a synergistic activity of Abamectin and the tested nicotinic acid derivatives was present.

### Example 22

Dilutions of a 10 g/l Milbemectin EC formulation as well as dilutions of mixtures of Milbemectin 10 g/l EC and neat tocopheryl acetate, all-rac alpha, Ph. Eur. 5^{th} Ed. (mixture ratio 1:3, 1:6 and 1:10, based on weight) were sprayed on bean plants (Vicia fabia) in a spray cabinet and mites (Tetranychus urticae) were transferred to the plants after the leaf surfaces were dry. The degree of leaf damage was recorded 6 days after the mites were placed on the plants, and ED50 values g Milbemectin and tocopheryl acetate/ha) were calculated for the Milbemectin products tested, table 22. The ED50 values are based on degree of leaf damage.

TABLE 22
Calculated ED50 (g Milbemectin and tocopheryl acetate/ha) for
the Milbemectin products tested on Tetranychus urticae on
Vicia fabia, ED50 values are based on % leaf damage

| Product | ED50_{obs} (g ai/ha) | ED50ₑₓₚ | F (exp/obs) |
|---|---|---|---|
| Milbemectin | 0.18 | — | — |
| 10 g/l EC | | | |
| Milbemectin 10 g/l | 0.46 | 0.72 | 1.57 |
| Tocopheryl acetate | | | |
| 30 g/l EC | | | |
| Milbemectin 10 g/l | 0.54 | 1.19 | 2.2 |
| Tocopheryl acetate | | | |
| 60 g/l EC | | | |
| Milbemectin 10 g/l | 0.46 | 1.94 | 4.2 |
| Tocopheryl acetate | | | |
| 100 g/l EC | | | |
| Tocopheryl acetate | >100 | — | — |
| 80 g/l EW | | | |

The F(exp/obs) values given in table 22 and calculated according to the Wadley method showed a synergistic action between Milbemectin and tocopheryl acetate was present.

### Example 23

Ivermectin, Doramectin, and tocopheryl aceate, all-rac alpha, Ph. Eur. 5^{th} Ed were tested alone on Trichostrongylus colubriformis, Teladorsagia (Ostertagia) circumcincta and Haemonchus contortus in a larvae feeding study. More than 100 larvae per dose were used. Mixtures of Ivermectin and tocopheryl acetate (1:10 based on weight) and Doramectin and tocopheryl acetate (1:10 based on weight) were tested as well. The response parameter was feeding inhibition. The results of the tests, i.e. the larvae feeding inhibition (LFI) values, are tabulated in Table 23. A Wadley like analysis of the results are tabulated as well. Tocopheryl acetate did not have any feeding inhibition activity in the tested dose range.

TABLE 23
Calculated LFI-50%, LFI-96% and LFI-99% in ppb are shown for
Ivermectin (IVM) and Doramectin (DOR) and for mixtures of Ivermectin
and Doramectin with tocopheryl acetate (TOCO) in a T. colubriformis,
T. circumcincta and H. contortus larvae feeding inhibition study.

| | | | | | |
|---|---|---|---|---|---|
| | LFIexp/ | | LFIexp/ | | |
| T. col. | LFIobs | T. cir. | LFIobs | H. con. | LFIexp/LFIobs |

LFI-50

| | | | | | | |
|---|---|---|---|---|---|---|
| IVM | 2.01 | — | 6.37 | — | 6.10 | — |
| DOR | 2.57 | — | 6.12 | — | 2.63 | — |
| IVM + | 2.27 | 0.89 | 4.88 | 1.31 | 3.25 | 1.88 |
| TOCO | | | | | | |
| DOR + | 1.99 | 1.29 | 5.18 | 1.18 | 2.47 | 1.06 |
| TOCO | | | | | | |

LFI-96

| | | | | | | |
|---|---|---|---|---|---|---|
| IVM | 8.63 | — | 12.59 | — | 32.12 | — |
| DOR | 8.04 | — | 13.14 | — | 10.37 | — |
| IVM + | 7.37 | 1.17 | 11.83 | 1.06 | 11.30 | 2.84 |
| TOCO | | | | | | |
| DOR + | 7.09 | 1.13 | 11.01 | 1.19 | 9.66 | 1.07 |
| TOCO | | | | | | |

LFI-99

| | | | | | | |
|---|---|---|---|---|---|---|
| IVM | 10.81 | — | 17.35 | — | 40.68 | — |
| DOR | 12.22 | — | 18.52 | — | 16.30 | — |
| IVM + | 9.05 | 1.19 | 14.12 | 1.23 | 17.47 | 2.33 |
| TOCO | | | | | | |
| DOR + | 8.77 | 1.39 | 15.47 | 1.20 | 12.02 | 1.36 |
| TOCO | | | | | | |

The LFI values given for IVM + TOCO and DOR + TOCO are based on the concentration of the active ingredients, i.e. IVM and DOR.

The calculations done according to Wadley and shown in Table 23 indicate that synergistic action of Ivermectin and tocopheryl acetate and Doramectin and tocopheryl acetate was pre-sent in the larvae feed inhibition study. The synergistic action of Ivermectin and tocepheryl acetate in the H. contortus experiment is of particular interest because the H. contortus iso-late used was Ivermectin resistant.

### Example 24

The in vitro synergistic activity of Emamectin benzoate and tocopheryl acetate, all-rac alpha, Ph. Eur. 5^{th} Ed was studied on adult sea lice (Lepeophtheirus salmonis), a fish parasite, in seawater in Petri dishes. Emamectin benzoate and tocopheryl aceate were tested at various concentrations. In addition, mixtures of Emamectin benzoate and tocopheryl aceate, ratio 1:10 based on weight, were tested as well.

Tocopheryl aceate did not have any activity in its own right. The relative potency of the mixture Emamectin benzoate and tocopheryl acetate (1:10) and Emamectin benzoate alone was 1:1.8 in the dose range 50-100 ppb Emamectin benzoate. That is, tocopheryl aceate worked as an Emamectin benzoate potentiator in the study.

### Example 25

Assessment of the activity of Selamectin (Stronghold 12% Selamectin) and tocopheryl acetate, all-rac alpha, Ph. Eur. 5^{th} Ed was made on cat fleas (Ctenocephalides felis felis). In vitro contact tests were done on both larvae and adult fleas. An in vitro larvae test based on systemic activity of the ingredients was made as well. In the tests the ingredients were tested alone. In addition, a mixture of Selamectin and tocopheryl acetate, 1:10 based on weight, was tested. The response parameter was inactivation of the fleas. Tocopheryl acetate did not have any activity in its own right.

The ED50 values are given in table 25, including a Wadley analysis of the results.

TABLE 25
ED50 values (ppm) for Selamectin, tocopheryl acetate and 1:10 mixture
of Selamectin and tocopheryl acetate on flea larvae and adult fleas.

| | Larvae | ED50exp/ | Adult | ED50exp/ | Larvae | |
|---|---|---|---|---|---|---|
| | contact | ED50obs | contact | ED50obs | systemic | ED50exp/ED50obs |
| Selamectin | 31 | — | 24330 | — | 1.5 | — |
| Selamectin + | 9.1 | 3.4 | 12650 | 1.9 | 0.83 | 1.8 |
| TOCO | | | | | | |

The ED50 values given for Selamectin + tocopheryl acetate are based on the concentration of Selamectin.

The Wadley analysis of the three tests shown in table 25 indicates that synergism between Selamectin and tocopheryl acetate was present.

### Example 26

A test on Onchocerca lienalis microfilariae was based on evaluating the mobility of the microfilariae exposed to various concentrations of Ivermectin alone, tocopheryl acetate, all-rac alpha, Ph. Eur. 5^{th} Ed. alone or a mixture of Ivermectin and tocopheryl acetate (1:10, based on weight). Tocopheryl acetate alone did not affect the mobility of the microfilaria in the concentration range tested. The EC50 value for Ivermectin alone was 5.8×10⁻⁶ M, while the EC50 value for Ivermectin when applied together with tocopheryl acetate was 4.2×10⁻⁷M. Thus, tocopheryl acetate potentiated the activity of Ivermectin on Onchocerca lienalis.

### Example 27

A mixture of Spinosad and tocopheryl acetate, all-rac alpha, Ph. Eur. 5^{th} Ed (1:10 based on weight) had a better activity on the larvae of Lucilia cuprina (sheep blowfly) than spinosad alone. Tocopheryl acetate alone had no activity in its own right. Based on several similar studies, the average R value (observed mortality/expected mortality), according to the Colby method, was 1.3 indicating the presence of a superadditive effect of Spinosad and tocopheryl acetate.

1-33. (canceled)

34: A method of obtaining a pesticidal composition containing a pesticide and a synergist, said composition having an actual pesticidal effect higher than the sum of pesticidal effects of each of the pesticide and the synergist when taken alone, comprising the step of replacing a part of the amount of pesticide, which is selected among the group consisting of glutamate- and GABA-gated chloride channel agonist pesticides, by a synergistic amount of a synergist selected among the group consisting of Vitamin E compounds and Niacin compounds.

35: The method according to claim 34, wherein between 5% and 97% by weight of pesticide is replaced by a synergistic amount of the synergist.

36: The method according to claim 34, wherein the weight ratio of pesticide to synergist is in the range of 20:1 to 1:30.

37: The a method according to claim 34, wherein the weight ratio of pesticide to synergist is in the range of 1:1.1 to 1:30.

38: The method according to claim 34, wherein the pesticide is selected among the group consisting of avermectins, milbemycins, spinosyns, and piperazine.

39: The method according to claim 34, wherein the synergist is at least one Vitamin E compound.

40: The method according to claim 34, wherein the Niacin compound is selected among the group consisting of optionally hydroxy substituted nicotinic acid and isonicotinic acid and salts and C₁₋₁₂alkylesters thereof, optionally hydroxy substituted nicotinamide and isonicotinamide, and salts thereof.

41: The method according to claim 34, wherein the pesticide is selected among the group consisting of Abamectin, Aversectin C, Doramectin, Emamectin, Eprinomectin, Ivermectin, Selamectin, Milbemectin, Milbemycin oxime, Moxidectin, Lepimectin, Nemadectin, Spinosad, Spinetoram, piperazine, and salts thereof.

42: A method of reducing the amount of pesticide in a pesticidal composition while maintaining a similar pesticidal effect, comprising the step of replacing a part of the amount of pesticide, which is selected among the group consisting of glutamate- and GABA-gated chloride channel agonist pesticides, by a synergistic amount of a synergist selected among the group consisting of Vitamin E compounds and Niacin compounds.

43: The method according to claim 42, wherein between 5% and 97% by weight of pesticide is replaced by a synergistic amount of the synergist.

44: The method according to claim 42, wherein the weight ratio of pesticide to synergist is in the range of 20:1 to 1:30.

45: The a method according to claim 42, wherein the weight ratio of pesticide to synergist is in the range of 1:1.1 to 1:30.

46: The method according to claim 42, wherein the pesticide is selected among the group consisting of avermectins, milbemycins, spinosyns, and piperazine.

47: The method according to claim 42, wherein the synergist is at least one Vitamin E compound.

48: The method according to claim 42, wherein the Niacin compound is selected among the group consisting of optionally hydroxy substituted nicotinic acid and isonicotinic acid and salts and C₁₋₁₂alkylesters thereof, optionally hydroxy substituted nicotinamide and isonicotinamide, and salts thereof.

49: The method according to claim 42, wherein the pesticide is selected among the group consisting of Abamectin, Aversectin C, Doramectin, Emamectin, Eprinomectin, Ivermectin, Selamectin, Milbemectin, Milbemycin oxime, Moxidectin, Lepimectin, Nemadectin, Spinosad, Spinetoram, piperazine, and salts thereof.

50: A method for controlling harmful pests on plants, comprising applying to a plant to be treated a composition containing a pesticide and a synergist, said composition having an actual pesticidal effect higher than the sum of pesticidal effects of each of the pesticide and the synergist when administered alone, wherein a part of the amount of pesticide, which is selected among the group consisting of glutamate- and GABA-gated chloride channel agonist pesticides, is replaced by a synergistic amount of a synergist selected among the groups consisting of Vitamin E compounds and Niacin compounds.

51: The method according to claim 50, wherein between 5% and 97% by weight of pesticide is replaced by a synergistic amount of the synergist.

52: The method according to claim 50, wherein the weight ratio of pesticide to synergist is in the range of 20:1 to 1:30.

53: The a method according to claim 50, wherein the weight ratio of pesticide to synergist is in the range of 1:1.1 to 1:30.

54: The method according to claim 50, wherein the pesticide is selected among the group consisting of avermectins, milbemycins, spinosyns, and piperazine.

55: The method according to claim 50, wherein the synergist is at least one Vitamin E compound.

56: The method according to claim 50, wherein the Niacin compound is selected among the group consisting of optionally hydroxy substituted nicotinic acid and isonicotinic acid and salts and C₁₋₁₂alkylesters thereof, optionally hydroxy substituted nicotinamide and isonicotinamide, and salts thereof.

57: The method according to claim 50, wherein the pesticide is selected among the group consisting of Abamectin, Aversectin C, Doramectin, Emamectin, Eprinomectin, Ivermectin, Selamectin, Milbemectin, Milbemycin oxime, Moxidectin, Lepimectin, Nemadectin, Spinosad, Spinetoram, piperazine, and salts thereof.

58: A method for controlling harmful pests in or on animals including humans, comprising administrating to an animal or a human in need thereof a pharmaceutical or veterinary effective amount of a composition containing a pesticide and a synergist, said composition having an actual pesticidal effect higher than the sum of pesticidal effects of each of the pesticide and the synergist when administered alone, wherein a part of the amount of pesticide, which is selected among the group consisting of glutamate- and GABA-gated chloride channel agonist pesticides, is replaced by a synergistic amount of a synergist selected among the group consisting of Vitamin E compounds and Niacin compounds.

59: The method according to claim 58, wherein between 5% and 97% by weight of pesticide is replaced by a synergistic amount of the synergist.

60: The method according to claim 58, wherein the weight ratio of pesticide to synergist is in the range of 20:1 to 1:30.

61: The a method according to claim 58, wherein the weight ratio of pesticide to synergist is in the range of 1:1.1 to 1:30.

62: The method according to claim 58, wherein the pesticide is selected among the group consisting of avermectins, milbemycins, spinosyns, and piperazine.

63: The method according to claim 58, wherein the synergist is at least one Vitamin E compound.

64: The method according to claim 34, wherein the Niacin compound is selected among the group consisting of optionally hydroxy substituted nicotinic acid and isonicotinic acid and salts and C₁₋₁₂alkylesters thereof, optionally hydroxy substituted nicotinamide and isonicotinamide, and salts thereof.

65: The method according to claim 58, wherein the pesticide is selected among the group consisting of Abamectin, Aversectin C, Doramectin, Emamectin, Eprinomectin, Ivermectin, Selamectin, Milbemectin, Milbemycin oxime, Moxidectin, Lepimectin, Nemadectin, Spinosad, Spinetoram, piperazine, and salts thereof.

66: A method for obtaining reduced application rates of a pesticide comprising the steps of
providing a pesticidal composition containing a pesticide, which is selected among the group consisting of glutamate- and GABA-gated chloride channel agonist pesticides, and an synergistic amount of a synergist selected among Vitamin E compounds and Niacin compounds,
applying the pesticidal composition to a plant in an amount sufficient for controlling harmful pest.

67: The method according to claim 66, wherein between 5% and 97% by weight of pesticide is replaced by a synergistic amount of the synergist.

68: The method according to claim 66, wherein the weight ratio of pesticide to synergist is in the range of 20:1 to 1:30.

69: The a method according to claim 66, wherein the weight ratio of pesticide to synergist is in the range of 1:1.1 to 1:30.

70: The method according to claim 66, wherein the pesticide is selected among the group consisting of avermectins, milbemycins, spinosyns, and piperazine.

71: The method according to claim 66, wherein the synergist is at least one Vitamin E compound.

72: The method according to claim 66, wherein the Niacin compound is selected among the group consisting of optionally hydroxy substituted nicotinic acid and isonicotinic acid and salts and C₁₋₁₂alkylesters thereof, optionally hydroxy substituted nicotinamide and isonicotinamide, and salts thereof.

73: The method according to claim 66, wherein the pesticide is selected among Abamectin, Aversectin C, Doramectin, Emamectin, Eprinomectin, Ivermectin, Selamectin, Milbemectin, Milbemycin oxime, Moxidectin, Lepimectin, Nemadectin, Spinosad, Spinetoram, piperazine, and salts thereof.

74: A method for obtaining reduced dose rates of a pesticide comprising the steps of
providing a pesticidal composition containing a pesticide, which is selected among the group consisting of glutamate- and GABA-gated chloride channel agonist pesticides, and an synergistic mount of a synergist selected among the group consisting of Vitamin E compounds and Niacin compounds,
administering the pesticidal composition to an animal or a human in need thereof in a pharmaceutical or veterinary effective amount sufficient for controlling harmful pest.

75: The method according to claim 74, wherein between 5% and 97% by weight of pesticide is replaced by a synergistic amount of the synergist.

76: The method according to claim 74, wherein the weight ratio of pesticide to synergist is in the range of 20:1 to 1:30.

77: The a method according to claim 74, wherein the weight ratio of pesticide to synergist is in the range of 1:1.1 to 1:30.

78: The method according to claim 74, wherein the pesticide is selected among the group consisting of avermectins, milbemycins, spinosyns, and piperazine.

79: The method according to claim 74, wherein the synergist is at least one Vitamin E compound.

80: The method according to claim 74, wherein the Niacin compound is selected among the group consisting of optionally hydroxy substituted nicotinic acid and isonicotinic acid and salts and C₁₋₁₂alkylesters thereof, optionally hydroxy substituted nicotinamide and isonicotinamide, and salts thereof.

81: The method according to claim 74, wherein the pesticide is selected among the group consisting of Abamectin, Aversectin C, Doramectin, Emamectin, Eprinomectin, Ivermectin, Selamectin, Milbemectin, Milbemycin oxime, Moxidectin, Lepimectin, Nemadectin, Spinosad, Spinetoram, piperazine, and salts thereof.

82: A composition comprising an active principle of
3% to 95% by weight of a pesticide, which is selected among the group consisting of glutamate- and GABA-gated chloride channel agonist pesticides and
5% to 97% by weight of a synergist, which is selected among the group consisting of Vitamin E compounds and Niacin compounds.

83: The composition according to claim 82, comprising an active principle of 10% to 80% by weight of pesticide and 20% and 90% by weight of synergist.

84: The composition according to claim 82, wherein the weight ratio of pesticide to synergist is in the range of 20:1 to 1:30.

85: The composition according to claim 82, wherein the weight ratio of pesticide to synergist is in the range of 1:1.1 to 1:30.

86: The composition according to claim 82, wherein the pesticide is selected among the group consisting of avermectins, milbemycins, spinosyns, and piperazine.

87: The composition according to claim 82, wherein the synergist is at least one Vitamin E compound.

88: The composition according to claim 82, wherein the Niacin compound is selected among the group consisting of optionally hydroxy substituted nicotinic acid and isonicotinic acid and salts and C₁₋₁₂alkylesters thereof, optionally hydroxy substituted nicotinamide and isonicotinamide, and salts thereof.

89: The method according to claim 82, wherein the pesticide is selected among the group consisting of Abamectin, Aversectin C, Doramectin, Emamectin, Eprinomectin, Ivermectin, Selamectin, Milbemectin, Milbemycin oxime, Moxidectin, Lepimectin, Nemadectin, Spinosad, Spinetoram, piperazine, and salts thereof.

90: The composition according to claim 82, which is adapted for use in a method of controlling harmful pests in beneficial crops.

91: The composition according to claim 82, wherein the composition is formulated for use in a method of controlling harmful pests in or on animals, including humans.

92: The composition according to claim 82, wherein the composition comprises at least one pesticide, at least one synergist and a carrier or solvent with the provisio that if the pesticide is an avermectin or a milbemycin and the synergist is Vitamin E then the composition does not comprises a pyrrolidone solvent in combination with a solvent selected among diethylene glycol monobutyl ether, benzyl benzoate, isopropyl alcohol and xylenes, and with the further provisio that if the pesticide agent is Ivermectin and the synergist is Vitamin E then the composition is not part of a nutritive composition.

93: Kit comprising (i) a first composition comprising at least one pesticide selected among the group consisting of glutamate- and GABA-gated chloride channel agonist pesticides and (ii) a second composition comprising a synergistic amount of a synergist selected among the group consisting of Vitamin E compounds and Niacin compounds.
